(19) United States
(12) Patent Application Publication
(10) Pub. No.: US 2026/0184879 A1
(43) Pub. Date: Jul. 2, 2026

(54) METHOD FOR REMOVING COLORANT AND ELASTOMERIC POLYMERS FROM MIXED TEXTILE FEEDSTOCK FOR RECYCLING

(71) Applicant: International Business Machines Corporation, Armonk, NY (US)

(72) Inventors: Gregory Breyta, San Jose, CA (US); Joseph Hadel, San Jose, CA (US); Amin Haghmoradi, San Jose, CA (US); Ting-Han Lee, San Jose, CA (US)

(21) Appl. No.: 19/424,429

(22) Filed: Dec. 18, 2025

Related U.S. Application Data
(60) Provisional application No. 63/740,393, filed on Dec. 31, 2024.

(51) Int. Cl. C08J 11/08; C08J 11/24; D06P 1/92; D06P 3/82; D06P 5/13

(52) U.S. Cl. CPC C08J 11/08; C08J 11/24; D06P 3/8209; D06P 3/8223; D06P 3/8276; D06P 5/13; C08J 2301/02; C08J 2367/02; C08J 2375/08; C08J 2377/06; D06P 1/928

(57) ABSTRACT

Chemical processing techniques for removing elastomeric polymers and colorant from mixed textile feedstocks for recycling are described. In an embodiment, a method can comprise contacting a heated solution comprising a solvent to a mixed textile feedstock as positioned within a vessel or chamber, wherein the mixed textile feedstock comprises elastomeric polymers or a combination of elastomeric polymers and a colorant, and wherein the solvent comprises a cyclic ketone. The method further comprises removing at least some of the elastomeric polymers (or both the elastomeric polymers and the colorant) as a result of the contacting, resulting in a transformation of the textile feedstock into a purified textile product that excludes the at least some of the elastomeric polymers (and the colorant when included in the textile feedstock). The mixed textile feedstock can comprise other types of textile materials (in addition to the elastomeric polymers), such as polyester, cotton, nylon, and others.

### TECHNICAL FIELD

The subject disclosure relates generally to chemical processing techniques for removing elastomeric polymers, colorants and other additives from mixed textile feedstock for recycling.

### BACKGROUND

Polyester is amongst the most commonly used global fiber market, ubiquitous in the fashion industry. The global fiber production reached 116 million tons in 2022, with synthetic fibers accounting for 65% of this total. Polyester fiber production alone reached 63.3 million tons, representing 54% of global fiber production, while cotton and nylon represent 22% and 5%. With continued population growth, global fiber production is expected to keep increasing at an annual growth rate of 1.2%. However, this significant production volume also leads to the generation of a large amount of textile waste. Less than 1% of textile waste is recycled fiber-to-fiber, with approximately 73% landfilled or incinerated, 14% lost during production and collection, and 12% downcycled into lower-value applications.

Most polyester textiles and mixed textile materials (e.g., blended fabrics containing polyester, cotton, and other synthetic and natural fibers) are dyed with colorants and contain elastomeric polymers such as spandex and others, making them difficult to recycle using current technology. Although methods exist for the removal of colorants from polyester material prior to recycling, these methods use toxic chemicals and have other substantial drawbacks. Thus, the vast majority of recycled polyester materials being colored, render them unsuitable for use in many downstream recycled products. Current methods of colorant removal from polyester materials for the purposes of recycling include pre-processing decolorization and post-processing decolorization.

With current pre-processing decolorization, the colored material is soaked in an aqueous solvent that extracts the dye or alternatively, the colored material is subjected to high-shear mixing. With the solvent soaking method, the solubility limits of the colorant material in the solvent and/or the relative partitioning of the colorant in the solvent versus the polymer limit the efficiency of the colorant extraction. Because of these limits, there is always a substantial amount of colorant remaining in the polyester. To partially circumvent this problem, large amounts of solvent are required, which render the process economically or environmentally unsuitable for commercial use. With the high-shear mixing, specific equipment and solvents are required that complicate the colorant extraction. For example, the solvent used in high-shear mixing decolorization is an ionic liquid, which requires mixing with water to remove the dye, and the water must be evaporated from the solution in order to reuse the solvent. Water requires a large quantity of energy to evaporate, a step that limits the economic viability of the process.

With post-processing decolorization of recycled polyester material, the polymer is depolymerized to oligomeric or monomeric materials, then the color is removed from a solution of the depolymerized material in a solvent, often with activated carbon or other adsorption materials for a continuous colorant extraction process. With solution color removal, the oligomer/monomer solution is exposed to an adsorbent, such as activated carbon, to remove the dissolved colorants. While solution color removal is capable of removing limited amounts of colorants, the process is overwhelmed by the large quantities of colorants found in dark-colored fabrics resulting in a technical and economical hurdle. To partially circumvent this problem, large amounts of adsorbent can be used, but this renders the process economically unsuitable for commercial use.

In addition, elastomeric polymers present within polyester fabrics and mixed fabric materials present several challenges for recycling such materials using existing methods. Many fabric recycling processes rely on mechanical or chemical methods designed for common fibers like cotton, polyester, or nylon. Elastomers have different physical and chemical properties, making them harder to separate and process. Elastomeric fibers often have low melting points and decompose rather than melting cleanly, complicating thermal recycling processes such as melt extrusion for synthetic fibers. Fabrics often blend elastomers with other fibers (e.g., cotton-spandex, cotton-polyester-spandex, polyester-spandex and nylon-spandex blends), making separation complex. Current mechanical recycling methods struggle to isolate elastomeric components from the main fiber feedstock. Many chemical recycling methods (e.g., depolymerization for polyester) are designed for specific polymer types. Elastomers can also partially break, potentially contaminating the recycling stream. Even in small amounts, elastomeric fibers can degrade the mechanical properties of recycled fibers, leading to weaker or lower-quality output materials. Because of these challenges, fabrics containing elastomeric polymers are often downcycled or discarded rather than fully recycled into new textile feedstocks.

In view of the foregoing, and since both the elastomer and dye content have potential value individually, there remains a need in the art for efficient methods of removing and recovering colorant and elastomeric polymers from fabrics in association with usage of the fabrics for generating recycled products.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later.

According to an embodiment, a method for producing a purified textile product is provided. The method comprises contacting a heated solution comprising a solvent to a mixed textile feedstock as positioned within a vessel or chamber, wherein the mixed textile feedstock comprises elastomeric polymers and one or more other textile materials, and wherein the solvent comprises a cyclic ketone. The method further comprises removing at least some of the elastomeric polymers as a result of the contacting, resulting in a transformation of the mixed textile feedstock into a purified textile product that excludes the at least some of the elastomeric polymers.

In another embodiment, a method for separating components of a mixed textile feedstock is provided, wherein the mixed textile feedstock comprises a colorant, elastomeric polymers and one or more other textile materials. The method comprises extracting at least some of the colorant from the mixed textile feedstock using a first extraction process resulting in an intermediate textile feedstock, wherein the first extraction process comprises contacting the textile feedstock to a first heated solution comprising a first solvent. The method further comprises extracting at least some of the elastomeric polymers from the intermediate textile feedstock using a second extraction process, resulting in a purified textile product that excludes the at least some of the colorant and the at least some of the elastomeric polymers, wherein the second extraction process comprises contacting the intermediate textile feedstock to a second heated solution comprising a second solvent different from the first solvent, wherein the first solvent and the second solvent are selected from the group consisting of: an alcohol, ether, ester, and a ketone.

In another embodiment, another method for separating components of a mixed textile feedstock is provided, wherein the mixed textile feedstock comprises a colorant, elastomeric polymers, and one or more textile materials. The method comprises extracting at least some of the colorant from the mixed textile feedstock using a first extraction process resulting in an intermediate textile feedstock, wherein the first extraction process comprises contacting the textile feedstock to a solution comprising a solvent in association with heating the solution to a first temperature, wherein the solvent comprises a cyclic ketone. The method further comprises extracting at least some of the elastomeric polymers from the intermediate textile feedstock using a second extraction process, resulting in a purified textile product that excludes the at least some of the colorant and the at least some of the elastomeric polymers, wherein the second extraction process comprises contacting the intermediate textile feedstock to the solution in association with heating the solution to a second temperature higher than the first temperature.

### BRIEF DESCRIPTION OF THE DRAWINGS

The Applicant hereby petitions the Director to accept color drawings and photographs in this application. The color drawings and photographs are necessary as the subject matter cannot be adequately understood in black and white.

One or more embodiments are described below in the Detailed Description section with reference to the following drawings:

FIG. 1 illustrates a flow diagram of an example, non-limiting method for removing elastomeric polymers and colorant from mixed textile feedstock, in accordance with one or more embodiments described herein;

FIG. 2 presents chemical structures of several example colorants capable of being removed from mixed textile feedstock, in accordance with one or more embodiments described herein;

FIG. 3 illustrates a flow diagram of an example, non-limiting method for selectively removing elastomeric polymers and colorant from mixed textile feedstock, in accordance with one or more embodiments described herein;

FIG. 4 illustrates a flow diagram of another example, non-limiting method for selectively removing elastomeric polymers and colorant from mixed textile feedstock, in accordance with one or more embodiments described herein;

FIG. 5 presents an example, non-limiting extraction system for removing elastomeric polymers, colorant, and other additives from mixed textile feedstock, in accordance with one or more embodiments described herein;

FIG. 6 illustrates an example implementation of a chemical recycling process for transforming a purified polyester product into a recycled polyester material, in accordance with one or more embodiments described herein.

FIG. 7 presents a table illustrating the impact of spandex removal on BHET as generated from the purified textile products in accordance with the disclosed methods;

FIG. 8 illustrates an example continuous flow reaction system in accordance with one or more embodiments described herein;

FIG. 9 illustrates another example continuous flow reaction system in accordance with one or more embodiments described herein;

FIG. 10 illustrates another example continuous flow reaction system in accordance with one or more embodiments described herein;

FIG. 11 illustrates another example continuous flow reaction system in accordance with one or more embodiments described herein;

FIG. 12A illustrates another example continuous flow reaction system as applied to the method of FIG. 3, in accordance with one or more embodiments described herein;

FIG. 12B illustrates another example continuous flow reaction system as applied to the method of FIG. 4, in accordance with one or more embodiments described herein;

FIGS. 13A and 13B presents a table illustrating results of Experiments 1-10;

FIGS. 14A-14C present images illustrating results of Experiments 1-10;

FIG. 15 present microscopic images of fabric before and after spandex removal, in accordance with Experiments 9 and 10.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The present innovation overcomes the need in the art with efficient extraction processes that remove colorant and elastomeric polymers from mixed textile feedstocks using non-toxic or environmentally friendly solvents and allowing for their recovery and reuse. The solvents can include, but are not limited to, cyclobutanone, cyclopentanone (CPO), cyclohexanone, 1,4-dioxane, 1,3-dioxolane, tetrahydrofuran, 2-methyl tetrahydrofuran, dimethyl carbonate, diethyl carbonate, ethyl lactate and ethyl acetate. The mixed textile feedstocks can include any textile feedstock containing elastomeric polymers. The elastomeric polymers can include, but are not limited to, elastane (also known as spandex), polyurethane (PU), and thermoplastic polyurethane (TPU) (e.g., used in elastane), ethylene-vinyl acetate (EVA) copolymers, thermoplastic elastomers (TPEs), polyvinyl chloride (PVC), terephthalate esters and amides, and others.

The term “mixed textile material,” “blended textile material”, and variations thereof, is used herein to refer to any textile material made from two or more different types of fibers or textile materials, which may be either blended at the fiber level or combined as layers or components in a finished fabric. In accordance with the disclosed techniques, at least one of the two or more different types of textile materials includes or otherwise incorporates elastomeric polymers. The other type or types of fibers or textile materials included in the mixed textile material can vary and may include (but are not limited to), a polyester material, a nylon material, an acrylic material, a natural fiber material (e.g., cotton, wool, silk, flax and other cellulosic materials), or man-made cellulosic fibers (MMCF's) such as linen and, viscose, and others. The terms “textile” and “fabric”, “cloth” and the like are used interchangeably unless context warrants particular distinction amongst the terms.

The extraction process disclosed herein are based on the mechanism of colorant and polymer dissolution when colored polyester and spandex and/or other types of elastomeric fibers are contacted with the cyclic ketone solvent. With respect to colorant incorporated in a mixed textile feedstock comprising dyed polyester, the disclosed extraction processes leverage the mechanism of polyester fabric dying process at certain temperature (110-130° C. (C.), which is usually higher than the glass transition temperature (Tg) of polyester, but also surprisingly work below the polymer Tg. Under this condition, the amorphous region of the polyester fiber becomes partially molecularly mobile and swellable, allowing dye molecules to disperse within the amorphous regions of the fibers. Therefore, instead of presenting how to embed additives into uncolored polyester fabric, the disclosed extraction processes demonstrate an effectiveness to extract additives from colored polyester fabric after dying processing based on same mechanism.

With respect to elastomeric fibers, during the dissolution process, owing to the factors such as polarity, chemical characteristics, and solubility parameters of the elastomeric polymer's chain and the solvent, the chain segments start to absorb solvent molecules, increasing the volume of the polymer matrix, and loosening out from their entangled shape. Finally, the mobile polymer chain will diffuse away from the swollen polymer, dispersing into a solution. In the meantime, due to these factors (e.g., polarity, chemical characteristics, and solubility parameters) and the conditions of the extraction process, the non-elastomeric fibers (e.g., polyester fibers, cotton fibers, and other synthetic and natural fibers) of the fabric feedstock are not affected by solvent and are unaffected. Thus, the remaining non-elastomeric fibers can be efficiently recovered using the disclosed extraction processes and chemically or mechanically recycled for reuse efficiently and produce a high-quality recycled product.

In one or more embodiments, an extraction process is provided that extracts both colorant and elastomeric polymers included in mixed textile feedstock. With these embodiments, the extraction processes involves contacting a solution comprising the cyclic ketone solvent with the mixed textile feedstock in association with heating the solution to a temperature between about 110° C. and about 170° C. In various implementations, the cyclic ketone solvent comprises cyclopentanone, cyclohexanone or a combination thereof.

For purposes of the present disclosure, “colorant” refers to any chemical substance, compound, mixture, pigment, dye, or coloration agent that imparts, modifies, enhances, or alters visible color, shade, hue, tint, tone, depth, or appearance of a textile material, including both coloration that is chemically bound to a fiber and coloration that is physically or mechanically adhered, applied, coated, or deposited on a fiber surface, unless context warrants particular distinction amongst the terms. The term colorant is intended to encompass all natural and synthetic dyes, pigments, inks, stains, tinting agents, and other chromophoric materials, whether water-soluble, solvent-soluble, dispersed, particulate, polymer-bound, or microencapsulated. In this regard, the terms “colorant,” “pigment,” “dye” and variations thereof, are used herein interchangeably, unless context warrants particular distinction amongst the terms.

This extraction process may also be applied to extract elastane from mixed textile feedstocks together with or excluding colorant, which can be recovered for reuse. In various embodiments, this extraction process can also extract other additives from the mixed textile feedstocks that may contaminate the recycled product, including but not limited to: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime.

With these embodiments, the resulting purified textile product (e.g., excluding or substantially excluding the elastane material, and in some implementations excluding colorant and other additives) is recovered and optionally efficiently transformed into a high-quality recycled product using existing chemical and/or mechanical recycling processes. For example, in some implementations in which the mixed textile feedstock comprises polyester, the purified textile product comprises purified polyester excluding the elastomers (and in some implementations colorant and other additives). With these implementations, the purified textile product may be transformed into a recycled polyester material via a chemical recycling process using glycolysis.

In other embodiments, additional extraction processes are provided that separately extract the colorant and elastomeric polymers included in mixed textile feedstocks. With these embodiments, in addition to recovering the purified textile product (e.g., excluding or substantially excluding the colorant and the elastomer material) which may be efficiently transformed into a high-quality recycled product using existing chemical and/or mechanical recycling processes, isolated colorant and isolated elastomeric polymers material can also be recovered and reused. These additional extraction processes can also extract other additives from the mixed textile feedstocks that may contaminate the recycled product, including but not limited to: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime.

These additional extraction processes include an orthogonal solvent-based extraction process and a temperature variation-based extraction process.

The orthogonal solvent-based extraction process involves first contacting a first solution comprising a first solvent with the mixed textile feedstock in association with heating the first solution to extract the colorant from the mixed textile feedstock. Thereafter, the decolored textile feedstock is contacted with a second solution comprising a second solvent in association with heating the second solution to extract the elastomeric polymers, wherein the first solvent and the second solvent are different. In some implementations, the first and second solvents are respectively selected from the group consisting of an ester, ether, an alcohol, and a ketone. For example, the aforementioned group may include, but is not limited to, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate. In some implementations, the first solution is heated to a first temperature in association with extracting the colorant and the second solution is heated to a second temperature higher than the first temperature in association with extracting the elastomeric polymers. For example, in some implementations, the first temperature is between about 50° C. and about 110° C. and the second temperature is between about 110° C. and about 150° C. In some embodiments, the orthogonal solvent-based extraction process can be reversed such that the elastane material is extracted first and thereafter the colorant is extracted or the elastane and colorant removed first followed by a second extraction to remove the colorant from the elastane.

The temperature variation process is similar to the orthogonal solvent-based extraction process, yet it involves using the same cyclic ketone solvent for both the colorant and the elastane material extraction. With these embodiments, the cyclic ketone solvent can include cyclobutanone, cyclopentanone, cyclohexanone, or a combination thereof. With these embodiments, the colorant is extracted at a first temperature and the elastomeric polymers are then extracted at a second temperature higher than the first temperature. For example, in some implementations, the first temperature is between about 50° C. and about 110° C. and the second temperature is between about 110° C. and about 170° C., and more preferably between about 120° C. and about 150° C.

In various implementations, some or all of the extraction processes disclosed herein further recover and reuse the extraction solvents (e.g., a cyclic ketone solvent) for multiple extractions over time using sequential batch processing or in a continuous flow extraction system. In accordance with the continuous flow extraction system, colorant and elastane material are removed from the fabric feedstock by placing the contaminated fabric feedstock (e.g., comprising colorant and/or elastane) within a chamber and exposing the material to a continuously condensed heated solvent that passes through the material as positioned within the chamber and extracts the respective components from the material. The solvent that has passed through the material may be subsequently recollected, reevaporated, recondensed, and passed back through the material within the chamber to extract additional components (e.g., additional colorant and/or elastane material) from the fabric over a duration of time until a desired amount of colorant and/or elastane has been removed.

Additionally, the continuous flow extraction system can include a mechanical conveyance mechanism that provides for continuously feeding additional contaminated fabric feedstock (e.g., comprising colorant and/or elastane) into the extraction chamber where the colorant and/or elastane material are extracted via contacting the fabric feedstock with the hot solvent, and removing the purified material from the chamber. In some implementations of these embodiments, the solvent solution is heated and directed into the chamber in a direction countercurrent to the feed flow of the contaminated fabric feedstock. In some embodiments in which the colorant and the elastomer are extracted separately, the continuous flow extraction system can include separate subsystems, one for the colorant extraction and another for the elastane extraction. With these embodiments, the mechanical conveyance mechanism can also provide for conveying fabric material from one chamber to the next.

One non-limiting example of a chemical recycling process that may use the purified textile products of the disclosed methods in implementation in which they include polyester is the glycolysis-based process (also referred to as the volatile catalyst (VolCat) method) described in U.S. Pat. No. 9,255,194 B2 to Allen et al. and U.S. Pat. No. 9,914,816 B2 to Allen et al. This glycolysis-based process depolymerizes polyester with an alcohol solvent and an amine organocatalyst and/or carboxylic acid salt of the same in a reactor at a temperature at or higher than the boiling point of the alcohol solvent. Reaction products from the glycolysis-based depolymerization are monomeric and/or oligomeric diesters from the polyester as well as recovered organocatalyst and excess alcohol solvent, the former of which is intended for reuse into recycled polyester products and the latter of which may also be reused in subsequent depolymerization reactions.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

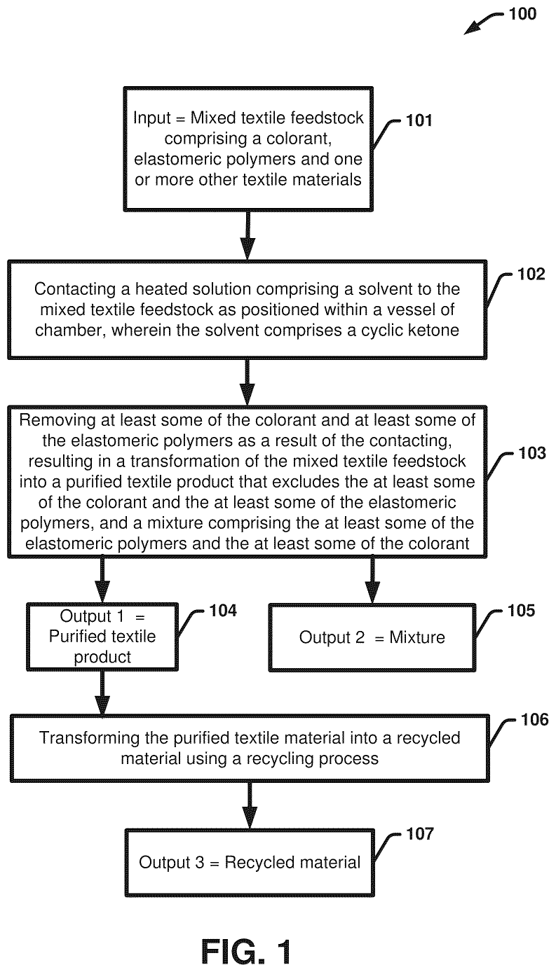

FIG. 1 illustrates a flow diagram of an example, non-limiting method 100 for removing both colorant and elastomeric polymers from mixed textile feedstock 101 comprising a colorant, elastomeric polymers, and one or more other textile materials, in accordance with one or more embodiments described herein.

In accordance with method 100, the elastomeric polymers of the mixed textile feedstock 101 can include, but are not limited to, elastane (also known as spandex), PU and/or TPU (e.g., used in elastane/spandex), EVA copolymers, TPEs, PVC, TPA), and combinations thereof. The one or more other textile materials or fibers included in mixed textile feedstock 101 can vary.

In some embodiments, the one or more other textile materials included in mixed textile feedstock 101 includes a polyester material. The polyester material can include, but is not limited to, polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly dialkyl diesters such as poly(butylene succinate) (PBS) and poly(butylene adipate) (PBA), and combinations thereof.

Additionally, or alternatively, the one or more other textile materials included in mixed textile feedstock 101 can include, polyamide material, a nylon material, an acrylic material, a polyolefin, a natural fiber material (e.g., cotton, wool, silk, flax and other cellulosic materials), or man-made cellulosic fibers (MMCF's) such as linen and viscose, and combinations thereof.

In some embodiments, the mixed textile feedstock 101 may also include one or more additive components such as but not limited to: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof.

In some embodiments, the amount of elastomeric polymers in the mixed textile feedstock 101 is between about 1% to about 60% by mass, with the remaining mass percentage being composed of the one or more other textiles materials noted above (e.g., a polyester material, a nylon material, an acrylic material, a polyolefin, a natural fiber material and/or an MMCF material), the colorant, and in some implementations one or more of the other aforementioned additive components. In other embodiments, the amount of elastomeric polymers in the mixed textile feedstock 101 is between about 1% to about 40% by mass, with the remaining mass percentage being composed of the one or more other textiles materials noted above (e.g., a polyester material, a nylon material, an acrylic material, a polyolefin, a natural fiber material and/or an MMCF material), the colorant, and in some implementations one or more of the other aforementioned additive components. In other embodiments, the amount of elastomeric polymers in the mixed textile feedstock 101 is between about 1% to about 20% by mass, with the remaining mass percentage being composed of the one or more other textiles materials noted above (e.g., a polyester material, a nylon material, an acrylic material, a polyolefin, a natural fiber material and/or an MMCF material), the colorant, and in some implementations one or more of the other aforementioned additive components. In other embodiments, the amount of elastomeric polymers in the mixed textile feedstock 101 is between about 1% to about 20% by mass, with the remaining mass percentage being composed of the one or more other textiles materials noted above (e.g., a polyester material, a nylon material, an acrylic material, a polyolefin, a natural fiber material and/or an MMCF material), the colorant, and in some implementations one or more of the other aforementioned additive components.

In embodiments in which the one or more other textile materials of the mixed textile feedstock 101 includes a polyester material (of amongst the aforementioned polyester materials) and the mixed textile feedstock 101 comprises between about 20% and 99% by mass of the polyester material, and preferably at least 50% by mass of the polyester material. In one or more implementations, the polyester material comprises PET. In some implementations of these embodiments, in addition to polyester and elastomeric polymers, the mixed textile feedstock 101 also include one or more other types of materials, such as but not limited to: a nylon material, an acrylic material, a polyolefin, a natural fiber material (e.g., cotton, wool, silk, flax and other cellulosic materials), and/or a MMCF material such as linen and, viscose, and combinations thereof).

In other embodiments, the one or more other textile materials of the mixed textile feedstock 101 includes a cotton material and the mixed textile feedstock 101 excludes other types of materials (e.g., polyester, nylon, etc.). In other words, the mixed textile feedstock 101 corresponds to cotton/elastomeric polymer blend. Still in other embodiments, the one or more other types of materials of the mixed textile feedstock 101 includes one or more of a nylon material, an acrylic material, a polyolefin, a natural fiber material (e.g., cotton, wool, silk, flax and other cellulosic materials), and/or a MMCF material such as linen and, viscose, and combinations thereof).

In some embodiments, as opposed to being in the form of a textile, fabric, cloth or the like, the input of method 100 may be in the form of a granulate, bottle flake, a sheet, a dense granulate, pellet, or a molded article. Bottle flake refers to small flakes of plastic obtained from recycled plastic bottles, typically made of PET. These flakes are produced by shredding used plastic bottles into small pieces after cleaning and removing labels and caps. With these embodiments, the composition of the input material can correspond to the compositions noted above as described with respect to the mixed textile feedstock 101.

In various embodiments, the colorant comprises a dye (e.g., a disperse dye, a vat dye, a direct dye, a sulfur dye, a reactive dye, an acid dye, and/or a cationic dye), a pigment, an ink, and/or another type of colorant. In some embodiments, the colorant includes or corresponds to a dye or pigment that has a chromophore based on a variety of chemical functionality (e.g., Azo dyes, Anthraquinone Dyes, benzodifuranone dyes, phthalocyanine dyes, violanthrone dyes, coumarin dyes, and the like). Generally, colorants used to dye polyester material are referred to as pigments, but can include particulate materials such as titanium dioxide. These colorants or pigments are deposited onto fibers of the polyester material as opposed to being chemically bonded thereto.

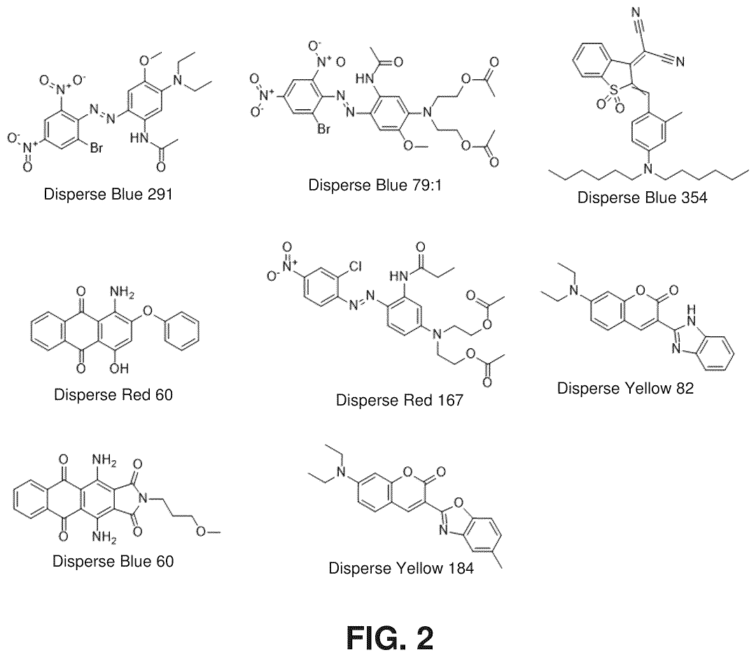

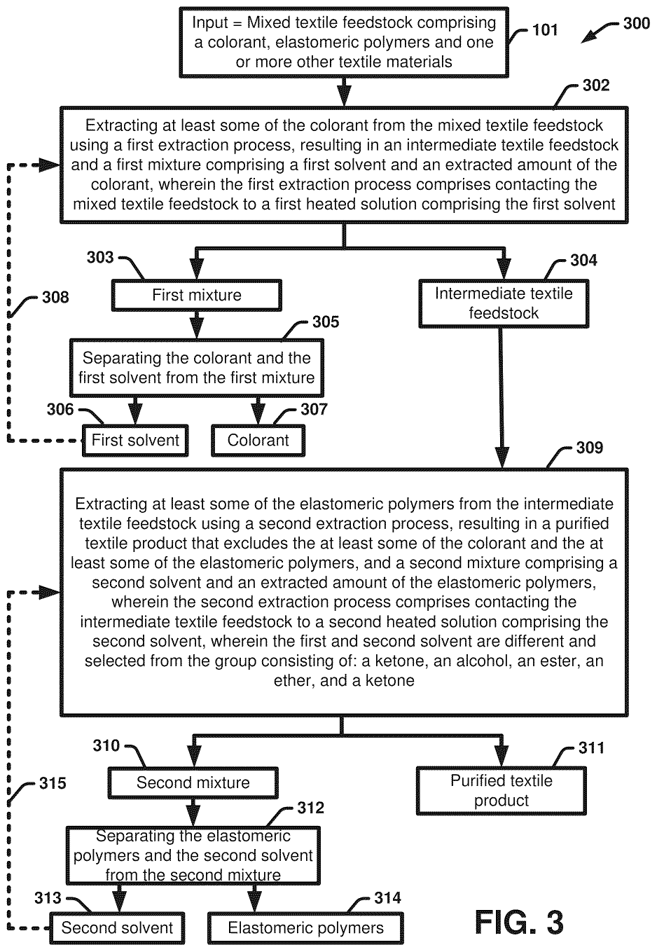

For example, FIG. 2 presents chemical structures of several example colorants capable of being removed from mixed textile feedstock 101, in accordance with one or more embodiments described herein. The colorants illustrated in FIG. 2 are disperse dyes which are widely used to color polyester. In various embodiments, the mixed textile feedstock 101 processed in accordance with method 100 and other methods described herein include colored polyester materials that have been dyed with one or more disperse dyes, such as those presented in FIG. 3. In accordance with these embodiments, method 100 and additional methods described herein can be adapted (e.g., as a function of temperature of the heated solution, concentration of the solvent, duration of contacting, number of repeated contacting steps, and other variables described herein) to remove all or substantially all of the colorant from the colored polyester material in addition to the elastomeric polymers. An addition to dye colorants our process also removes optical brighteners which are used to alter the appearance of the fabric

Dyeing polyester is more complex than dyeing natural fibers because polyester is a synthetic fiber with a hydrophobic (water-repelling) nature. To achieve deep and long-lasting colors, disperse dyes and high-temperature conditions (e.g., between about 110-130° C.) are typically used. Under this condition, the amorphous region of the polyester fiber becomes partially molecularly mobile and swellable, allowing dye molecules to disperse within the amorphous regions of the polyester fibers. In various embodiments, in accordance with method 200 and other methods described herein, to remove disperse dyes and other colorants from colored polyester material, the heated solution comprising the solvent is heated to a temperature that is lower than the melting point temperature of the polyester material.

With reference again to FIG. 1 and method 100, at 102 method 100 comprises contacting a heated solution comprising a solvent with the mixed textile feedstock 101 as positioned within a vessel or chamber, wherein the solvent comprises a cyclic ketone. In various embodiments, the cyclic ketone comprises 5 to 10 carbon atoms. In various embodiments, the cyclic ketone comprises cyclopentanone, cyclohexanone or a combination thereof. In some embodiments, in association with the contacting the concentration of the solvent relative to the mixed textile feedstock 101 is about 1 part by mass of mixed textile feedstock 101 to about 50 parts by mass of solvent. In preferred embodiments, the concentration of the mixed textile feedstock 101 relative to the solvent is about 1 part by mass of mixed textile feedstock to about 10 parts by mass of solvent.

At 103, method 100 comprises removing at least some of the colorant and at least some of the elastomeric polymers as a result of the contacting, resulting in a transformation of the mixed textile feedstock 101 into a purified textile product 104 (output 1) that excludes the at least some of the colorant and at least some of the elastomeric polymers. In addition, the output of the extraction process can include a mixture 105 comprising the at least some of the elastomeric polymers combined with the colorant (output 2).

In this regard, the purified textile product 104 excludes at least some of the colorant and at least some of the elastomeric polymers relative to the mixed textile feedstock 101 yet retains the one or more other textile materials, such as polyester, cotton, nylon, etc. when included in the mixed textile feedstock 101. As described in greater detail throughout, the amount of colorant and elastomeric polymers removed from the mixed textile feedstock 101 via method 100 and other methods described herein can vary depending on the solvent used from amongst the optional solvents, the duration of contacting, the amount of the elastomeric polymers included in the mixed textile feedstock 101, the temperature of the heated solvent, the concentration of the solvent relative to the mass percentage of the mixed textile feedstock 101, whether cotton or another cellulosic material is present (in which case some colorant may remain with the cotton) and other factors. With the embodiments described herein, these factors can be tailored to obtain a purified textile product 104 that has less than 2.0 percent by weight of the elastomeric polymers and colorant and/or less than 1.0 percent by weight of the elastomeric polymers and colorant.

In embodiments in which the mixed textile feedstock 101 also includes one or more additive components such as but not limited to: a colorant, a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof, the removing also includes removing these one or more additive components as a result of the contacting as well. In other words, the mixture 105 corresponding to output 2 also includes an extracted amount of the one or more additive components when included in the mixed textile feedstock 101, such that the purified textile product 104 that has less than 1.0 percent by weight of these additive components.

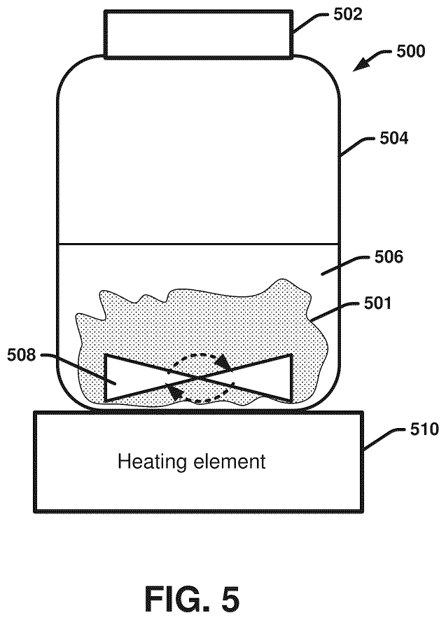

In various embodiments, the contacting of method 100 can be performed as a batch process using extraction system 500 (or a similar extraction system) as described with reference to FIG. 5. With these embodiments, the mixed textile feedstock 101 and the solvent (in solution form) are placed within a vessel which is heated to a target temperature for a duration of time. In some implementations of these embodiments, as applied to removing all or substantially all elastomeric polymers and colorant from the mixed textile feedstock 101, the target temperature is between about 50° C. to about 170° C. and the duration of time is between about 1 minute and about 60 minutes. In another implementation of these embodiments, the target temperature is between about 110° C. to about 170° C. and the duration of time is between about 1 minute and about 15 minutes. In other implementations of these embodiments, the target temperature is between about 110° C. to about 150° C. and the duration of time is between about 2 minutes and about 10 minutes. Still in other implementations of these embodiments, the target temperature is between about 120° C. to about 140° C. and the duration of time is between about 2 minutes and about 10 minutes. Additional details regarding the execution of method 100 using extraction system 500 (or a similar extraction system) are described with reference to FIG. 5.

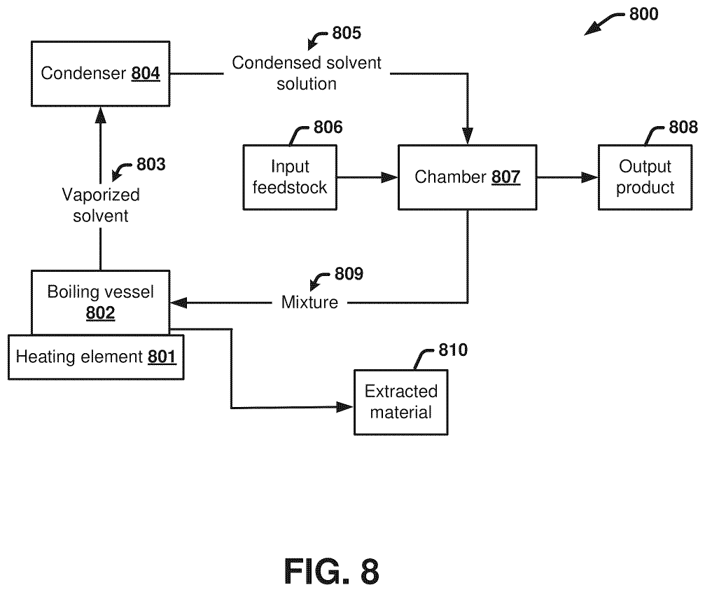

In other embodiments, the contacting of method 100 can be performed using a continuous flow reaction system, as described with reference to FIGS. 8-11. With these embodiments, the mixed textile feedstock 101 is placed withing a chamber for a duration of time and contacted with the heated solvent solution over the duration of time in a continuous or cyclical manner. With these embodiments, the heated solvent solution corresponds to a condensed solvent solution and/or a heated condensed solvent solution. In some implementations of these embodiments, as applied to removing all or substantially all elastomeric polymers and colorant from the mixed textile feedstock 101, the condensed solvent solution is heated to a target temperature between about 110° C. and about 170° C. in association with the contacting and the duration of time is between about 2 minutes to 60 minutes. In other implementations of these embodiments, the condensed solvent solution is heated to a target temperature between about 110° C. and about 160° C. in association with the contacting and the duration of time is between about 1 hour and about 24 hours. Still in other implementations of these embodiments, the condensed solvent solution is heated to a temperature between about 120° C. and about 150° C. in association with the contacting and the duration of time is between about 2 minutes and 60 minutes. Additional details regarding the continuous flow reaction process are described with reference to FIGS. 8-11.

In some embodiments, method 100 can end after the removal of the elastomeric polymers and colorant (and in some implementations any of the aforementioned additive components) at 103. For example, the purified textile product 104 may be removed from the vessel or chamber, dried and used as is. In other embodiments, at 106, the purified textile product 104 may be transformed into a recycled material using a recycling process, resulting in output (e.g., output 3) of a recycled material. In this regard, because the purified textile product 104 resulting from method 100 is free or substantially free elastomeric polymers (and preferably colorant and/or other additive substances discussed herein), the purified textile product 104 can be efficiently transformed into a high quality recycled material without additional pre-processing or post-processing steps to remove the elastomeric polymers. The recycling process can vary depending on the contents of the purified textile product and the desired type of recycled material 107 to be obtained. In some embodiments, the recycling process can include a chemical recycling process. In other embodiments, the recycling process can include a mechanical recycling process.

For example, in some embodiments in which the mixed textile feedstock 101 (and thus the purified textile product 104) includes a polyester material such as PET, at 106, method 100 may further comprise transforming the purified polyester product (wherein the purified textile product 104 corresponds to the purified polyester product) into a recycled polyester material using a suitable recycling process. In another example, in embodiments in which the mixed textile feedstock 101 (and thus the purified textile product 104) includes polyamide material such as a nylon material e.g. Nylon 6 or Nylon 6,6), method, at 106, method 100 may further comprise transforming the purified polyamide product (wherein the purified textile product 104 corresponds to the purified polyamide product) into a recycled polyamide material using a suitable recycling process.

The recycling process can include any existing or further developed mechanical or chemical recycling process applicable to polyester material. Suitable chemical recycling processes include hydrolysis or solvolysis processes such as methanolysis. Another example of an applicable recycling process that may be performed at 106 in embodiments in which the purified textile product 104 comprises PET or polyamides comprises a chemical recycling process using glycolysis. With this implementation, the recycled material 107 (output 3) comprises Bis(2-hydroxyethyl)terephthalate (BHET) or a repolymerized version of the BHET into a recycled polyester. In various embodiments, the glycolysis-based recycling process corresponds to the volatile catalyst (VolCat) method described in U.S. Pat. No. 9,255,194 B2 to Allen et al. and U.S. Pat. No. 9,914,816 B2 to Allen et al. The VolCat process depolymerizes PET rapidly via glycolysis using an organocatalyst into the molecule Bis(2-hydroxyethyl)terephthalate (BHET), which can be repolymerized into a recycled polyester material. This process has drawn industrial interest due to its potential to valorize low-cost waste streams and divert a sizeable portion of polyester waste from landfills. The technology is well suited to process bottle flake inputs by extracting the PET component from other plastics and additives during the solution process. The VolCat process is less resilient against contamination from components found in textiles, such as increased amounts of elastomeric polymers, colorants and other additive substances disclosed herein (e.g., lubricant agents, brightener agents, perfluoroalkyl substances, polyfluoroalkyl substances, scouring agents, anti-foam agents, leveling agents, wicking agents, and the like).

More particularly, the depolymerization of polyester by glycolysis with ethylene glycol has been found to proceed rapidly in the presence of an organocatalyst. For bottle flakes, the additives present are typically insoluble and filtered post-glycolysis. Due to the ease of sorting bottle flakes much of the uncolored portion of this feedstock is fit for mechanical recycling, especially as the capabilities of materials recycling/recovery facilities (MRFs) have increased. Currently, since the majority of clothing is highly colored and usually contains pigments such as titanium dioxide recyclers are unable to use thermomechanical recycling, leaving waste PET clothing (i.e., PET fabric materials) outside the capabilities of the current recyclables market. However, a portion of these fabrics with little or no color can be processed by chemical recycling. The challenge is most polyester fabrics contain increased amounts of elastomeric polymers, dyes and other additive substances disclosed herein that are known to be detrimental to the quality of the monomer product obtained from chemical recycling processes such as VolCat. This places a burden on the downstream purification processes required to increase the quality of the monomer, which the disclosed techniques mitigate.

Method 100 and other methods disclosed herein thus provide the necessary pre-treatment step to remove elastomeric polymers, colorant and other additive substances from PET and other polyester materials including fabric prior to depolymerization via glycolysis, thus greatly extending the application of the VolCat process and other textile polymer recycling process to textiles and fabrics currently being landfilled or incinerated. Additionally, method 100 and additional processes described herein provide techniques to recover the colorants and elastomers individually for reuse and valorization.

For example, in some embodiments of method 100, the respective components in the mixture 105 may be separated/isolated from one another using one or more additional extraction processes. With these embodiments, the isolated components (e.g., elastomers, colorant, and in some implementations other additive components noted above) may be recovered and reused. For example, the colorants can be separated from mixture 105 by partial evaporation or cooling, or by selective dissolution away from the mixture using a different solvent, leaving purified elastomer. The (recovered) colorant may be used to dye additional materials. Likewise, the (recovered) elastomeric polymers may be used in other products, including textile products and non-textile products.

It should be appreciated that method 100 may be applied to decolored mixed textile feedstock comprising elastomeric polymers and one or more other textile materials. In other words, method 100 can be applied to remove elastomeric polymers (and other additives when included) from mixed textile feedstock excluding colorant. With these embodiments, the one or more other textile materials of the decolored mixed textile feedstock may include (but are not limited to), a polyester material, a cotton material, a nylon material, an acrylate material, a polyolefin material, an animal fiber material, and/or man-made cellulosic fiber material.

FIG. 3 illustrates a flow diagram of an example, non-limiting method 300 for selectively removing colorant and elastomeric polymers from mixed textile feedstock, in accordance with one or more embodiments described herein. The input to method 300 comprises the mixed textile feedstock 101 described with reference to FIG. 1 and method 100. Repetitive description of like elements employed in respective embodiments is omitted for sake of brevity.

Method 300 differs from method 100 with the usage of two separate extraction process, one applied to selectively remove colorant, and another applied to selectively remove the elastomeric polymers. In various embodiments, method 300 is referred to as an orthogonal solvent-based extraction process because it uses two different solvents to facilitate the selective removal of colorant and elastomeric polymers.

At 302, method 300 comprises extracting at least some of the colorant from the mixed textile feedstock 101 using a first extraction process resulting in an intermediate textile feedstock 304 and a first mixture 303 comprising a first solvent and an extracted amount of the colorant, wherein the first extraction process comprises contacting the mixed textile feedstock 101 to a first heated solution comprising the first solvent.

At 309, method 300 comprises extracting at least some of the elastomeric polymers from the intermediate textile feedstock 304 using a second extraction process, resulting in a purified textile product 311 that excludes the at least some of the colorant and the at least some of the elastomeric polymers, and a second mixture 310 comprising a second solvent and an extracted amount of the elastomeric polymers, wherein the second extraction process comprises contacting the intermediate textile feedstock 304 to a second heated solution comprising the second solvent, wherein the first and second solvent are different and selected from the group consisting of, a ketone, an alcohol, an ester, an ether, and a ketone.

In various embodiments the aforementioned group includes (but is not limited to) cyclobutanone, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate as examples. In various embodiments, the second solvent comprises cyclopentanone, and/or cyclohexanone, and the first solvent comprises cyclobutanone, 1,4-dioxane, 1,3-dioxolane, tetrahydrofuran, 2-methyl tetrahydrofuran, dimethyl carbonate, diethyl carbonate, ethyl lactate and/or ethyl acetate.

In some embodiments, in addition to the solvent used, the temperature of the first and second extraction processes can also vary. For example, in some implementations, the first heated solution is heated to a first temperature between about 50° C. to about 120° C., and more preferably between about 70° C. and about 100° C. and wherein the second heated solution is heated to a second temperature between about 110° C. to about 150° C., and more preferably between about 120° C. and about 140° C. In this regard, removal of elastomeric polymers generally requires a higher temperature relative to the removal of colorant and usage of a cyclic ketone solvent (e.g., cyclopentanone, and/or cyclohexanone), while colorant may be selectively removed (e.g., without removing the elastane) using any of the aforementioned solvents at a lower temperature. However, both colorant and elastomeric polymers may be removed together (in accordance with method 100) using a cyclic ketone solvent (e.g., cyclopentanone, and/or cyclohexanone) at the higher temperature ranges (e.g., between about 110° C. to about 170° C., and more preferably between about 120° C. and about 150° C.).

In this regard, the purified textile product 311 excludes at least some of the colorant and at least some of the elastomeric polymers relative to the mixed textile feedstock 101 yet retains the one or more other textile materials, such as a polyester material and/or other materials such as cotton, nylon, etc. when included in the mixed textile feedstock 101. As described in greater detail throughout, the amount of colorant and elastomeric polymers removed from the mixed textile feedstock 101 via method 300 and other methods described herein can vary depending on the solvent used from amongst the optional solvents, the duration of contacting, the amount of the elastomeric polymers included in the mixed textile feedstock 101, the temperature of the heated solvent, the concentration of the solvent relative to the mass percentage of the mixed textile feedstock 101, whether cotton or another cellulosic material is present (in which case some colorant may remain with the cotton) and other factors. With the embodiments described herein, these factors can be tailored to obtain a purified textile product 104 that has less than 2.0 percent by weight of the elastomeric polymers and colorant and/or less than 1.0 percent by weight of the elastomeric polymers and colorant.

In embodiments in which the mixed textile feedstock 101 also includes one or more additive components such as but not limited to: a colorant, a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof, the first extraction process at 302 and/or the second extraction process at 309 also effectively removes these additive components. In other words, the first mixture 303 and/or the second mixture 310 also includes the one or more additive components as extracted from the mixed textile feedstock 101 when included in the mixed textile feedstock 101, such that the purified textile product 311 has less than 1.0 percent by weight of these additive components.

In various embodiments, the first and second extraction processes of method 300 can be performed as a batch process using extraction system 500 (or a similar extraction system) as described with reference to FIG. 5. With these embodiments, the mixed textile feedstock 101 and the solvent (in solution form) are placed within a vessel which is heated to a target temperature for a duration of time. Additional details regarding performance of the first extraction process and the second extraction process of method 300 using system 500 or a similar system are described with reference to FIG. 5.

In other embodiments, the first and second extraction processes of method 300 can be performed using a continuous flow reaction system, as described with reference to FIGS. 8-11. With these embodiments, the mixed textile feedstock 101 is placed withing a chamber for a duration of time and contacted with the heated solvent solution over the duration of time in a continuous or cyclical manner. Additional details regarding performance of the first extraction process and the second extraction process of method 300 using a continuous flow reaction system are described with reference to FIGS. 8-11.

At 305, method 300 can further comprise separating the (extracted amount of) colorant and the first solvent from the first mixture 305, resulting in (recovered) colorant 307 and (recovered) first solvent 306. For example, this can be accomplished via evaporation of the first solvent from the first mixture 305, resulting in isolation of the colorant, and then recondensing the evaporated solvent into the recovered solvent. Additionally, or alternatively, the first solvent and the colorant may be separated via filtration. With either of these embodiments, as indicated via dashed arrow line 308, the (recovered) first solvent 306 may be reused in subsequent processes, such as another performance of the first extraction process at 302 as applied to the mixed textile feedstock 101 (e.g., in association with another instance of contacting using fresh solvent) and/or another performance of the first extraction process at 302, yet as applied to additional mixed textile feedstock corresponding to the mixed textile feedstock 101. Additional details regarding recovering and reusing the first solvent 306 are described in greater detail with reference to FIGS. 8-12A. In addition, the (recovered) colorant 307 may be used to dye new materials.

Similarly at 312, method 300 can further comprise separating the (extracted amount of) elastomeric polymers and the second solvent from the second mixture 310, resulting in (recovered) elastomeric polymers 314 and (recovered) second solvent 313. For example, this can be accomplished via evaporation of the second solvent from the second mixture 310, resulting in isolation of the elastomeric polymers, and then recondensing the evaporated second solvent into the recovered second solvent. Additionally, or alternatively, the second solvent and the elastomeric polymers may be separated via filtration. With either of these embodiments, as indicated via dashed arrow line 315, the (recovered) second solvent 313 may be reused in subsequent processes, such as another performance of the second extraction process at 309 as applied to the mixed textile feedstock 101 (e.g., in association with another instance of contacting using fresh solvent) and/or another performance of the second extraction process at 309, yet as applied to additional intermediate textile feedstock corresponding to the intermediate textile feedstock 304. Additional details regarding recovering and reusing the second solvent are described in greater detail with reference to FIGS. 8-12A. In addition, the recovered elastomeric polymers may be used for another purpose.

The purified textile product 311 may be removed from the vessel or chamber used in the first and/or second extraction processes, dried and, in some implementations used as is. In other embodiments, the purified textile product 311 may be transformed into a recycled material using a recycling process. In this regard, because the purified textile product 311 resulting from method 300 is free or substantially free elastomeric polymers and colorant (and other additive substances discussed herein when included in the mixed textile feedstock 101), the purified textile product 311 can be efficiently transformed into a high quality recycled material without additional pre-processing or post-processing steps to remove the elastomeric polymers. The recycling process can vary depending on the contents of the purified textile product 311 and the desired type of recycled material to be obtained. In some embodiments, the recycling process can include a chemical recycling process. In other embodiments, the recycling process can include a mechanical recycling process.

For example, in some embodiments in which the mixed textile feedstock 101 (and thus the purified textile product 311) includes a polyester material such as PET, method 300 may further comprise transforming the purified polyester product (wherein the purified textile product 311 corresponds to the purified polyester product) into a recycled polyester material using a suitable recycling process. In another example, in embodiments in which the mixed textile feedstock 101 includes (and thus the purified textile product 311) a nylon material (e.g. Nylon 6 or Nylon 6,6), method 300 may further comprise transforming the purified nylon product (wherein the purified textile product 311 corresponds to the purified nylon product) into a recycled nylon material using a suitable recycling process. The recycling process can include any existing or further developed mechanical or chemical recycling process applicable to the corresponding purified material included in the purified textile product 311 (e.g., polyester, nylon, and/or other textile materials disclosed herein).

For example, suitable chemical recycling processes include hydrolysis or solvolysis processes such as methanolysis. Another example of an applicable recycling process that may be performed in embodiments in which the purified textile product 311 comprises PET or polyamides comprises a chemical recycling process using glycolysis, as described with reference to FIG. 1 and method 100. In various embodiments, the glycolysis-based recycling process corresponds to the volatile catalyst (VolCat) method described in U.S. Pat. No. 9,255,194 B2 to Allen et al. and U.S. Pat. No. 9,914,816 B2 to Allen et al. The VolCat process depolymerizes PET rapidly via glycolysis using an organocatalyst into the molecule Bis(2-hydroxyethyl)terephthalate (BHET), which can be repolymerized into a recycled polyester material.

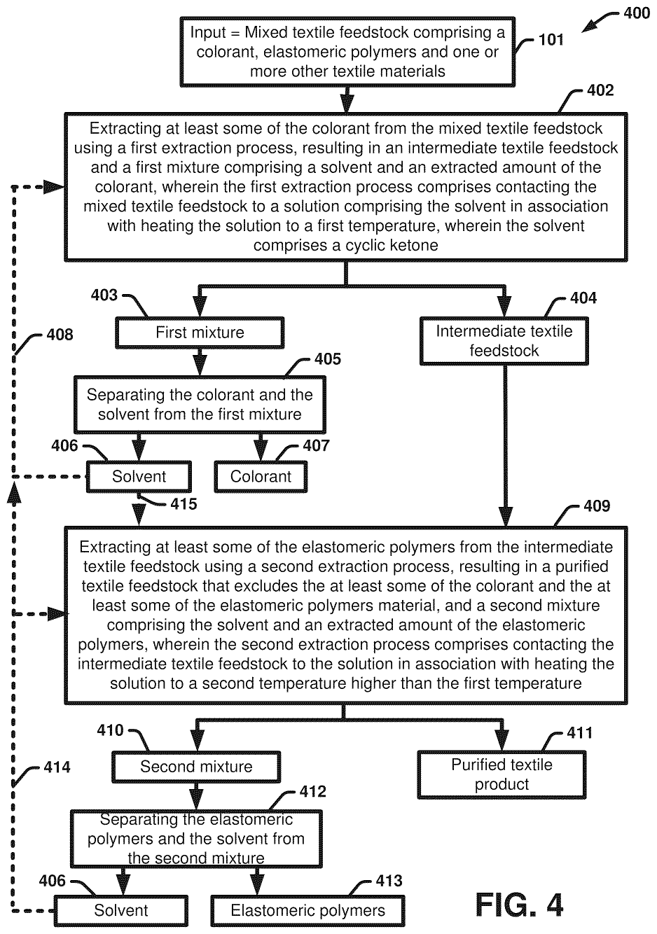

FIG. 4 illustrates a flow diagram of another example, non-limiting method 400 for selectively removing colorant and elastomeric polymers from mixed textile feedstock, in accordance with one or more embodiments described herein. The input to method 400 comprises the mixed textile feedstock 101 previously described. Repetitive description of like elements employed in respective embodiments is omitted for sake of brevity.

Method 400 is similar to method 300, yet as uses the same solvent and different temperatures to selectively remove the colorant and the elastomeric polymers. To this end, method 400 is referred to as a temperature variation-based extraction process.

At 402, method 400 comprises extracting at least some of the colorant from the mixed textile feedstock 101 using a first extraction process, resulting in an intermediate textile feedstock 404 and a first mixture 403 comprising a solvent and an extracted amount of the colorant, wherein the first extraction process comprises contacting the mixed textile feedstock 101 to a solution comprising the solvent in association with heating the solution to a first temperature, wherein the solvent comprises a cyclic ketone. In various embodiments, the cyclic ketone is selected from the group consisting of: cyclobutanone, cyclopentanone, cyclohexanone. In other embodiments, the cyclic ketone comprises cyclopentanone and/or cyclohexanone.

At 409, method 400 comprises extracting at least some of the elastomeric polymers from the intermediate textile feedstock 404 using a second extraction process, resulting in a purified textile product 411 that excludes the at least some of the colorant and the at least some of the elastomeric polymers, and a second mixture 410 comprising the solvent and an extracted amount of the elastomeric polymers, wherein the second extraction process comprises contacting the intermediate textile feedstock 404 to the solution (or another solution comprising the solvent) in association with heating the solution to a second temperature higher than the first temperature.

In this regard, method 400 uses the same solvent for both the first and second extraction processes. In various embodiments, the first temperature is between about 50° C. to about 110° C., the second temperature is between about 110° C. to about 170° C. In other embodiments, the first temperature is between about 75° C. to about 110° C., and the second temperature is between about 120° C. to about 150° C.

In this regard, the purified textile product 411 excludes at least some of the colorant and at least some of the elastomeric polymers relative to the mixed textile feedstock 101 yet retains the one or more other textile materials, such as a polyester material and/or other materials such as cotton, nylon, etc. when included in the mixed textile feedstock 101. As described in greater detail throughout, the amount of colorant and elastomeric polymers removed from the mixed textile feedstock 101 via method 400 and other methods described herein can vary depending on the solvent used from amongst the optional solvents, the duration of contacting, the amount of the elastomeric polymers included in the mixed textile feedstock 101, the temperature of the heated solvent, the concentration of the solvent relative to the mass percentage of the mixed textile feedstock 101, whether cotton or another cellulosic material is present (in which case some colorant may remain with the cotton) and other factors. With the embodiments described herein, these factors can be tailored to obtain a purified textile product 104 that has less than 2.0 percent by weight of the elastomeric polymers and colorant and/or less than 1.0 percent by weight of the elastomeric polymers and colorant.

In embodiments in which the mixed textile feedstock 101 also includes one or more additive components such as but not limited to: a colorant, a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, and combinations thereof, the first extraction process at 402 and/or the second extraction process at 409 also effectively removes these additive components. In other words, the first mixture 403 and/or the second mixture 410 also includes the one or more additive components as extracted from the mixed textile feedstock 101 when included in the mixed textile feedstock 101, such that the purified textile product 411 has less than 1.0 percent by weight of these additive components.

In various embodiments, the first and second extraction processes of method 400 can be performed as a batch process using extraction system 500 (or a similar extraction system) as described with reference to FIG. 5. With these embodiments, the mixed textile feedstock 101 and the solvent (in solution form) are placed within a vessel which is heated to a target temperature for a duration of time. Additional details regarding performance of the first extraction process and the second extraction process of method 400 using system 500 or a similar system are described with reference to FIG. 5.

In other embodiments, the first and second extraction processes of method 400 can be performed using a continuous flow reaction system, as described with reference to FIGS. 8-11. With these embodiments, the mixed textile feedstock 101 is placed withing a chamber for a duration of time and contacted with the heated solvent solution over the duration of time in a continuous or cyclical manner. Additional details regarding performance of the first extraction process and the second extraction process of method 400 using a continuous flow reaction system are described with reference to FIGS. 8-11.

At 405, method 400 can further comprise separating the extracted amount of colorant and the solvent from the first mixture 403, resulting in (recovered) colorant 407 and (recovered) solvent 406. For example, this can be accomplished via evaporation of the solvent from the first mixture 403, resulting in isolation of the colorant, and then recondensing the evaporated solvent into the recovered solvent. Additionally, or alternatively, the solvent and the colorant may be separated via filtration. With these embodiments, as indicated via dashed arrow line 408, the (recovered) solvent 406 these more may be reused in subsequent processes, such as another performance of the first extraction process as applied to the mixed textile feedstock 101 (e.g., in association with another instance of contacting using fresh solvent) and/or another performance of the first extraction process as applied to additional mixed textile feedstock corresponding to the mixed textile feedstock 101. Additionally, or alternatively, as indicated via dashed arrow line 415, the (recovered) solvent 406 may be used in the second extraction process. In other words, the solution of the second process may be formed with the (recovered) solvent 406. In addition, the (recovered) colorant 407 may be used to dye other materials.

Similarly at 412, method 400 can further comprise separating the extracted amount of elastomeric polymers and the solvent from the second mixture 410, resulting in (recovered) elastomeric polymers 413 and (recovered) solvent 406. For example, this can be accomplished via evaporation of the solvent from the second mixture 410, resulting in isolation of the elastomeric polymers, and then recondensing the evaporated solvent into the (recovered) solvent 406. Additionally, or alternatively, the solvent and the elastomeric polymers may be separated via filtration. With either of these embodiments, as indicated via dashed arrow line 414, the (recovered) solvent 406 as extracted from the second mixture 410 may be reused in subsequent processes, such as another performance of first extraction process at 402 as applied to additional mixed textile feedstock corresponding to the mixed textile feedstock 101, and/or another performance of the second extraction process at 409 as applied to the intermediate textile feedstock 404 (e.g., in association with another instance of contacting using fresh solvent) and/or another performance of the second extraction process as applied to additional intermediate textile feedstock corresponding to the intermediate textile feedstock 404. Additional details regarding recovering and reusing the solvent from the first mixture 403 and/or the second mixture 410 are described in greater detail with reference to FIGS. 8-12B. In addition, the (recovered) elastomeric polymers 413 may be used for another purpose.

The purified textile product 411 may be removed from the vessel or chamber used in the first and/or second extraction processes, dried and, in some implementations used as is. In other embodiments, the purified textile product 411 may be transformed into a recycled material using a recycling process. In this regard, because the purified textile product 411 resulting from method 400 is free or substantially free elastomeric polymers and colorant (and other additive substances discussed herein when included in the mixed textile feedstock 101), the purified textile product 411 can be efficiently transformed into a high quality recycled material without additional pre-processing or post-processing steps to remove the elastomeric polymers. The recycling process can vary depending on the contents of the purified textile product 411 and the desired type of recycled material to be obtained. In some embodiments, the recycling process can include a chemical recycling process. In other embodiments, the recycling process can include a mechanical recycling process.

For example, in some embodiments in which the mixed textile feedstock 101 (and thus the purified textile product 411) includes a polyester material such as PET, method 400 may further comprise transforming the purified polyester product (wherein the purified textile product 411 corresponds to the purified polyester product) into a recycled polyester material using a suitable recycling process. In another example, in embodiments in which the mixed textile feedstock 101 includes (and thus the purified textile product 411) a nylon material (e.g. Nylon 6 or Nylon 6,6), method 400 may further comprise transforming the purified nylon product (wherein the purified textile product 411 corresponds to the purified nylon product) into a recycled nylon material using a suitable recycling process. The recycling process can include any existing or further developed mechanical or chemical recycling process applicable to the corresponding purified material included in the purified textile product 411 (e.g., polyester, nylon, and/or other textile materials disclosed herein).

For example, suitable chemical recycling processes include hydrolysis or solvolysis processes such as methanolysis. Another example of an applicable recycling process that may be performed in embodiments in which the purified textile product 411 comprises PET or polyamides comprises a chemical recycling process using glycolysis, as described with reference to FIG. 1 and method 100. In various embodiments, the glycolysis-based recycling process corresponds to the volatile catalyst (VolCat) method described in U.S. Pat. No. 9,255,194 B2 to Allen et al. and U.S. 9,914,816 B2 to Allen et al. The VolCat process depolymerizes PET rapidly via glycolysis using an organocatalyst into the molecule Bis(2-hydroxyethyl)terephthalate (BHET), which can be repolymerized into a recycled polyester material.

FIG. 5 presents an example, non-limiting extraction system (hereinafter system 500) for removing elastomeric polymers, colorant and other additive components from mixed textile feedstock, in accordance with one or more embodiments described herein. System 500 includes heating element 510 and a vessel 504 comprising an enclosure 502 (a lid or the like) and a stirring apparatus 508 (which may be removed in some implementations). In some embodiments, extraction system 500 can include or correspond to a high-pressure batch reactor, such as a Parr high-pressure batch reactor manufactured by the company Parr Instrument Company or a similar high pressure batch reactor adapted for processing large amounts of polyester material on an industrialized level. High-pressure batch reactors operate as a closed system, meaning reactants are loaded into the vessel and sealed before the reaction and products are removed after completion. In other embodiments, extraction system 500 can include or correspond to an open system (e.g., performed under ambient pressure). In some implementations, the stirring apparatus 508 can include or correspond to a magnetic or mechanical stirring apparatus. In other implementations, other means of mechanical agitation for uniform mixing of reactants may be used.

The heating element 510 can include or correspond to an electrical heater or external jacket that provides for precise temperature control and may include cooling coils for rapid temperature control adjustments. In some embodiments in which reaction system 500 corresponds to a high-pressure batch reactor, the reaction system 500 can includes a gas introduction apparatus (not shown) that allows for controlled gas injection (e.g., nitrogen, oxygen, hydrogen, etc.) for reactions requiring pressurized or inert gases.

With reference to FIG. 5 in view of FIGS. 1-4, as noted above, in some embodiments, the contacting of method 100 and the first and second extraction processes of methods 300 and 400 may be performed using extraction system 500 or a similar system. With these embodiments, the input textile feedstock 501, which may correspond to mixed textile feedstock 101, intermediate textile feedstock 304 or intermediate textile feedstock 404 depending on implementation, is placed within the vessel 504 along with solvent solution 506 comprising the solvent (from amongst the optional solvents) and heated to the target temperature (via the heating element 510) for a duration of time. The amount of feedstock relative to the amount of solvent is preferably 1 parts by mass to 50 parts by mass, and more preferably 1 part by mass to 10 parts by mass.

The duration of time and the target temperature can vary depending on the particular solvent (amongst the applicable solvents noted with respect to method 100, method method 300 and method 400) used in the solvent solution, the concentration of the solvent relative to the amount of input textile feedstock, the material composition of the input textile feedstock 601, the amount of elastomeric polymers and/or colorant to be removed, and other factors.

As applied to method 100 and removing both elastomeric polymers and colorant from mixed textile feedstock 101, the target temperature is between 110° C. and 170° C., preferably between 120° C. and 150° C., and even more preferably between 130° C. and 140° C., and the duration of time is between about 1 minutes and about 30 minutes, and more preferably between about 4 minutes and about 20 minutes, and even more preferably between about 4 minutes and about 6 minutes.

As applied to the first extraction process (e.g., colorant removal from mixed textile feedstock 101) of methods 300 and 400, the target temperature is between 50° C. and 110° C., and more preferably between 70° C. and 100° C., and the duration of time is between about 1 minute and about 60 minutes, and more preferably between about 2 minutes and about 10 minutes. In some embodiments, the first extraction process of methods 300 and 400 may be performed using system 500 over multiple (e.g., two or more iterations) using fresh solvent solution until no colorant is visible observable. With these embodiments, the duration of contact at each iteration is preferably between about 1 minute and to about 10 minutes.

As applied to the second extraction process of methods 300 and 400 (e.g., elastomeric polymer removal from intermediate textile feedstock 304 and intermediate textile feedstock 404, respectively), the target temperature is between 110° C. and 170° C., preferably between 120° C. and 150° C., and even more preferably between 130° C. and 140° C., and the duration of time is between about 1 minutes and about 30 minutes, and more preferably between about 4 minutes and about 20 minutes, and even more preferably between about 4 minutes and about 6 minutes.

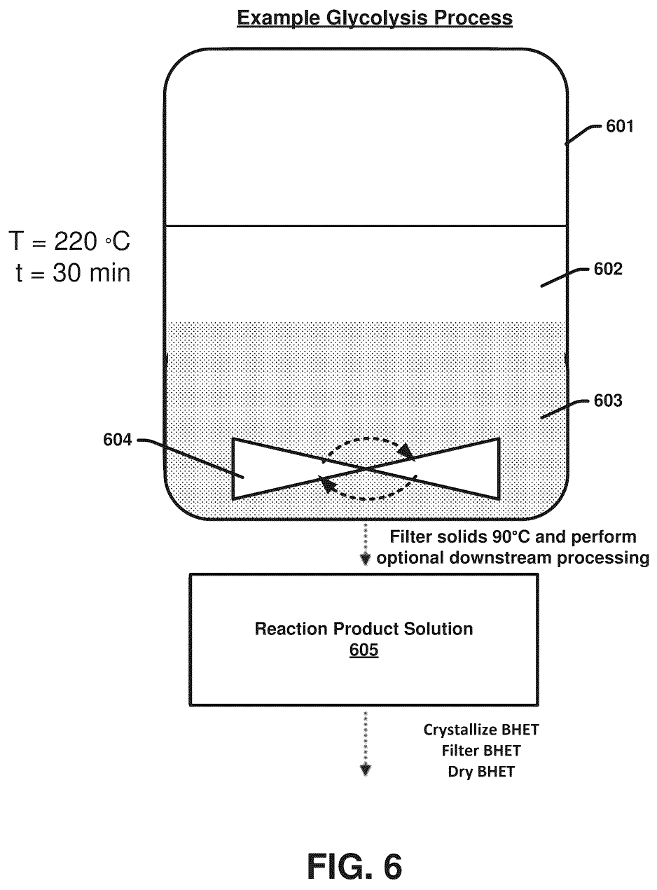

FIG. 6 illustrates an example implementation of a glycolysis process for transforming a purified textile product 603 into a recycled polyester material, in accordance with one or more embodiments described herein. In various embodiments, this glycolsis process corresponds to the VolCat process described above. This glycolysis process is applicable to any purified textile product 603 that comprises PET and excludes colorant and elastomers. For example, the purified textile product 603 can correspond to purified textile product 104, purified textile product 311, and/or purified textile product 411 and/or purified textile product 508. In this regard, the purified textile product 603 comprises polyester and excludes elastomeric polymers and/or colorant (preferably both). For example, as described above, as a result of performance of methods 100, 300 and/or 400 to generate the purified textile product 603, the purified textile product 603 has less than 2% mass and more preferably substantially less than 1% mass of elastomeric polymers and colorant combined.

As illustrated in FIG. 6, the glycolysis process involves placing the purified textile material 603 within an optionally pressurized vessel 601 as dissolved within a solvent solution 602 comprising an organocatalyst such as ethylene glycol. The pressurized vessel 601 may include or correspond to the vessel that is part of a high-pressure batch reactor system (e.g., system 500 or a similar system), such as a Parr high-pressure batch reactor manufactured by the company Parr Instrument Company or a similar high pressure batch reactor, as described with reference to FIG. 5. The pressurized vessel 601 is then heated to a temperature of about 220° C. for a reaction duration of about 30 minutes while stirring via a stir bar 604 (or another mechanical stirring apparatus). This reaction causes the PET of the purified textile material 603 to transform into BHET. Thereafter, the pressurized vessel 601 is cooled to around 90° C. or less and any solids (aside from BHET) are filtered out of the reaction mixture, leaving a crude product solution 605 comprising the generated BHET and possibly any residual contaminates (e.g., residual elastomeric polymers) that may have remained with the purified textile product 603. The BHET is then crystallized, and precipitated or filtered out of the crude product solution 605 and dried. In various embodiments, because the purified textile material 603 excludes or substantially excludes elastomeric polymers and colorant (and in some implementations other additives disclosed herein), the resulting BHET obtained also excludes or substantially excludes elastomeric polymers, colorant (and other additives as applicable).

In an example experimental implementation of method 100 (hereinafter Experiment A) using system 500 (or a similar system) combined colorant and elastomeric polymers were removed from fabric samples corresponding to mixed textile feedstock 101 and the resulting purified fabric samples were transformed into BHET using the glycolysis process described above. Under the conditions of Experiment A, a BHET product was achieved that contained only 0.1% by weight of elastomeric polymers (which in this experiment were spandex).

### Experiment A

In accordance with Experiment A, the mixed textile feedstock 101 corresponded to colored two identical PET fabric samples containing 2% by weight of PU (e.g., spandex) and dyes. One of the PET fabric samples (referred to as sample 1) was placed in the vessel (e.g., vessel 504, vessel 601 or the like) of a high pressure reactor system (e.g., system 500 or the like) and heated to a temperature of 130° C. for a duration of 5 minutes. The sample was then removed compressed to remove residual solvent and dried under heat, vacuum and nitrogen flow. The purified sample was then transformed into BHET using glycolysis (e.g., the glycolysis process above). The second sample (referred to as sample 2) was processed separately using the same reaction system. yet heated to a temperature of 140° C. for a duration of 5 minutes, and thereafter transformed into BHET using the glycolysis process. The solvent used for the PU and colorant extraction for both samples was cyclopentanone. In addition, a third fabric sample (referred to as sample 3), identical to the first and second PET fabric samples, was transformed into BHET via the same glycolysis process, yet without pre-treatment (e.g., without performance of spandex/colorant removal).

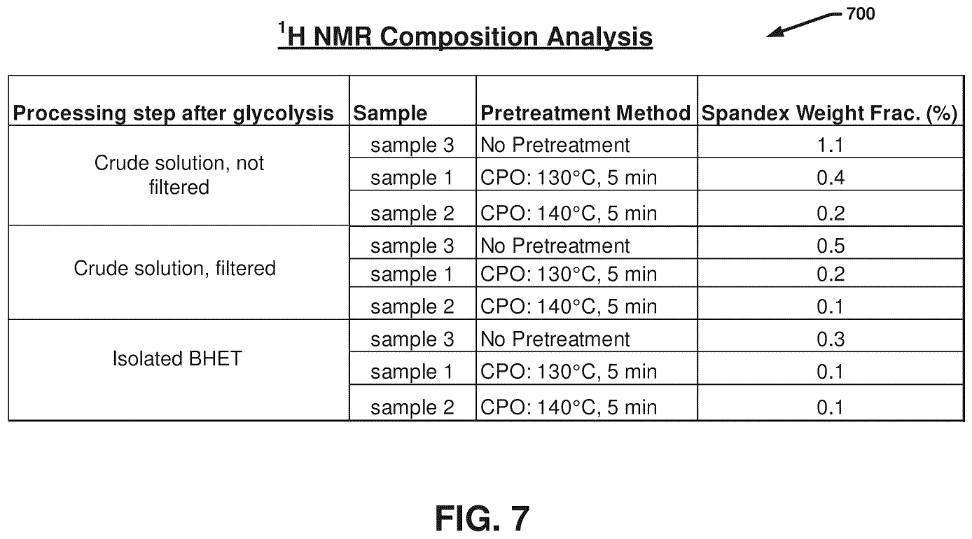

FIG. 7 presents a table (Table 700) demonstrating the results of Experiment A. Table 700 presents the H NMR composition analysis of the BHET outputs of the glycolysis process for all three samples. The outputs analyzed included the crude reaction product solution (not filtered), the crude reaction product solution following filtering, and the isolated BHET. As shown in Table 700, the first and second samples resulted in an isolated BHET product that contained 0.1% by weight of spandex byproduct, while the third sample without pre-treatment included 0.3% by weight of spandex byproduct, thus demonstrating the effectiveness of the disclosed extraction processes as a pre-treatment step for producing BHET with significantly less spandex byproduct contamination.

FIG. 8 illustrates an example continuous flow reaction system (hereinafter system 800) in accordance with one or more embodiments described herein. With reference to FIG. 8 in view of FIGS. 1-4, as noted above, in some embodiments, the contacting of method 100 and the first and second extraction processes of methods 300 and 400 may be performed using a continuous flow reaction system, such as system 800 or a similar system. With these embodiments, the input feedstock 806 can correspond to mixed textile feedstock 101, intermediate textile feedstock 304 or intermediate textile feedstock 404, depending on the implementation. Likewise, the output product 808 can correspond to purified textile product 104, intermediate textile feedstock 304, purified textile product 311, intermediate textile feedstock 404, or purified textile product 411, depending on implementation.

System 800 includes, but is not limited to, heating element 801, boiling vessel 802, condenser 804, and chamber 807. The actual implementation of system 800 can vary with respect to the physical arrangement and size of these components so long as they are respectively connected to one another via suitable conduits (aside from the heating element 801 which is merely removably coupled to the boiling vessel 802). In this regard, it should be appreciated that the boiling vessel 802 is connected to the condenser 804 via a suitable conduit, the condenser 804 is connected to the chamber 807 via a suitable conduit, and the chamber 807 is connected to the boiling vessel 802 via a suitable conduit. For example, in some embodiments, system 800 may include or correspond to a Soxhlet extractor or a variation thereof as adapted for industrial processing of vast amounts of input feedstock 806.

As indicated via the arrowed lines, FIG. 8 also provides a high-level flow of the extraction process performed using system 800, (hereinafter, Flow Process 1) in accordance with one or more embodiments. Flow process 1 is performed may be performed in a single-pass, repeatedly, step-wise (as with multiple solvents), or continuously. In this regard, in association with initiation of Flow Process 1, the input feedstock 806 is placed within the chamber 807. As described in greater detail below, in some embodiments, this can involve continuously or regularly feeding in input feedstock 806 into the chamber 807 (e.g., via a mechanical conveyance or another mechanism), maintaining the input feedstock 806 therein for a duration of time in association with contacting a condensed solvent solution 805 thereto within the chamber 807 to extract (at least some of) the elastomeric polymers and/or the colorant therefrom, either collectively or selectively, thereby transforming the input feedstock 806 into output product 808, and removing the output product 808 from the chamber 807 after the duration of time (e.g., via mechanical conveyance or another mechanism).

In this regard, over the duration of time in which the input feedstock 806 is maintained within the chamber 807, Flow Process 1 comprises repeatedly or continuously heating the boiling vessel 802 via heating element 801 to a target temperature (e.g., the solvent's boiling point temperature) to transform solvent within the boiling vessel 802 into a vaporized solvent 803. Depending on the implementation (e.g., the contacting of method 100, first or second extraction processes of method 300, or the first or second extraction processes of method 400), the solvent and/or the target temperature can vary. For example, as described with reference to methods 100, 300 and 400, depending on implementation, the solvent may include can include cyclobutanone, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate, ethyl acetate and/or combinations thereof. In this regard, the heating temperature of heating element 801 can correspond to the boiling point of the solvent used, which can vary. For example, the boiling points of the optional solvents disclosed herein (e.g., cyclobutanone, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate) range from about 66° C. to about 130° C.

The (hot) vaporized solvent 803 travels into the condenser 804 where it is condensed and transformed into the condensed solvent solution 805. The condensed solvent solution 805 is directed into the chamber 807 where it contacts the input feedstock 806 therein and extracts or otherwise removes from the input feedstock 806, the colorant, the elastomers, or both, depending on implementation (and in some implementations other additive components discussed herein when included in the input feedstock 806) therefrom, forming a mixture 809 comprising the solvent and an extracted amount of the colorant and/or elastomeric polymers. The mixture is 809 is further directed out of the chamber 807 and into the boiling vessel 802. In some embodiments, the mixture 809 may be directed out of the chamber 807 and into the boiling vessel 802 at a controlled rate. For example, the mixture 809 may be slowly leaked out of the chamber 807 as new condensed solvent solution 805 enters the chamber 807 in a continuous manner. In another implementation, an entirety of the mixture 809 within the chamber 807 may be flushed out of the chamber 807 regularly at a defined rate.

In either implementations, the mixture 809 is directed out of the chamber 807 and into the boiling vessel 802 where it is reheated to transform the solvent therein back into the vaporized solvent 803, which is again directed to the condenser 804 where it is transformed into the condensed solvent solution 805, which is further directed into the extraction chamber 807 where it extracts additional colorant and/or elastomeric polymers from the input feedstock 806 contained therein, and forms (additional) mixture 809, which is then directed into the boiling vessel 802, and so on. System 800 and Flow Process 1 thus not only effectively removes elastomeric polymers and/or colorant (and other additive components disclosed herein when included in the input feedstock 806) from the input feedstock 806 but also reuses the same solvent over and over.

In this regard, Flow Process 1 is performed on continuous loop over the duration of time while the input feedstock 806 is maintained within the chamber 807. The duration of time refers to the amount of time the input feedstock 806 is maintained within the chamber 807 and exposed to the condensed solvent solution 805. The duration of time can be adapted based whether elastomeric polymers, colorant, or both are being removed, the desired amount of elastomeric polymers and/or colorant to be removed, the concentration of the elastomeric polymers and/or colorant included in the input feedstock 806, the temperature of the condensed solvent solution 805 (which may be controlled, as described infra), and the particular solvent used. The duration of time can also be tailored as a function of the rate of evaporation of the solvent, the rate of condensation of the vaporized solvent, and the rate and amount of influx of condensed solvent solution 805 into the chamber 807, the size of the chamber, and the like, which can vary based on the architecture of system 800. Flow Process 1 may also continue to be performed on a continuous loop over sequential durations of time as new input feedstock (e.g., corresponding to input feedstock 806) is regularly or continuously fed into the chamber 807 and output product 808 is regularly or continuously removed from the chamber 807.

In association with heating the mixture 809 included in the boiling vessel 802, the solvent is vaporized out of the mixture 809 and transformed into the vaporized solvent 803 resulting in aggregation of the extracted material 810 (e.g., elastomeric polymers, colorant, and/or other components) within the boiling vessel 802 over time. In various embodiments, the extracted material 810 can be removed from the boiling vessel, recovered (e.g., via evaporation and/or filtration) and reused (e.g., to dye another material in implementations in which the extracted material 810 includes a colorant or reuse of the elastomers). The manner and timing at which the extracted material 810 is removed from the boiling vessel 802 can vary.

In this regard, Flow Process 1 can be summarized as follows:

### Flow Process 1

1. Placing the input feedstock 806 in the chamber 807 of the continuous flow reaction system 800 for a duration of time, the input feedstock 806 containing elastomeric polymers and/or colorant.
2. Performing a reaction process over the duration of time using the continuous flow reaction system to transform the input feedstock 806 into the output product 808, wherein the reaction process comprises repeatedly or continuously:
   a. contacting a condensed solvent solution 805 comprising a solvent to the input feedstock 806;
   b. forming a mixture 807 comprising the condensed solvent solution and an extracted amount of elastomeric polymers and/or colorant within the chamber 807 as a result of the contacting;
   c. collecting the mixture 807 within the boiling vessel 802; and
   d. heating the boiling vessel 802 to transform the solvent within the mixture into the vaporized solvent 803, wherein the vaporized solvent travels into the condenser and forms the condensed solvent solution 805; and
   e. directing the condensed solvent solution 805 into the chamber 807.
3. Removing the output feedstock 808 from the chamber 807 after the duration of time.

In various embodiments, using Flow Process 1 as applied to method 100, the input feedstock 106 corresponds to mixed textile feedstock 101, the output product 808 corresponds to purified textile product 104, and mixture 809 corresponds to mixture 105. The contacting of method 100 with these embodiments corresponds to the contacting of the condensed solvent solution 805 with the mixed textile feedstock 101 as positioned within chamber 807, which is performed repeatedly or continuously over the duration of time while the mixed textile feedstock 10 is maintained within the chamber 807. As noted with respect to method 100, the solvent used to remove the elastomeric polymers from the mixed textile feedstock 101 can include a cyclic ketone such as cyclopentanone and/or cyclohexanone. Preferably, the temperature of the condensed solvent solution 805 within the chamber 807 is between about 110° C. and about 150° C. in association with the contacting, and more preferably between about 130° C. and about 150° C. The duration of time and the temperature can vary (depending on the amount of elastomeric polymers and colorant included in the mixed textile feedstock 101 and other factors described herein). In various embodiments, as applied to method 100, in order to remove all or substantially all elastomeric polymers and colorant from the mixed textile feedstock 101 such that the output product 808 contains less than 1% by mass of elastomeric polymers, the duration of time can range between 1 minute and 60 minutes.

With this embodiment, the extracted material 810 includes a combination of colorant and elastomeric polymers. This extracted material 810 may correspond to mixture 809 (which includes the solvent), or a solid-form mixture comprising both the colorant and the elastomeric polymers with the solvent evaporated therefrom (e.g., via the boiling vessel 802). As described with reference to method 100, in some embodiments, the colorant and the elastomeric polymers as included in the extracted material may be separated from one another using an additional extraction process to render isolated colorant and isolated elastomeric polymers, which may respectively be reused in other applications.

In various embodiments, using Flow Process 1 as applied to method 300, Flow Process 1 is performed twice, with the first time corresponding to the first extraction process of method 300 performed at 302, and the second time corresponding to the second extraction process of method 300 performed at 309. With these embodiments, at the first iteration of Flow Process 1, the input feedstock 806 corresponds to mixed textile feedstock 101, the output product 808 corresponds to intermediate textile feedstock 304, mixture 809 corresponds to first mixture 303, and extracted material 810 corresponds to colorant 307 (e.g., with the solvent removed via evaporation using boiling vessel 802 or another filtration process). At this first iteration, in order to selectively remove colorant from the mixed textile feedstock 101, the first solvent can include any of the optional solvents disclosed herein. For example, the first solvent can include an alcohol, an ether, an ester, and/or a ketone. More particularly, the first solvent can include cyclobutanone, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate, ethyl acetate, and/or combinations thereof. Preferably, the temperature of the condensed solvent solution 803 within the chamber 807 is between about 50° C. and about 100° C. in association with the contacting. The duration of time can vary (depending on the amount of colorant included in the mixed textile feedstock 101 and other factors described herein). In various embodiments, in order to remove all or substantially all colorant from the mixed textile feedstock 101 such that the output product 808 contains less than 1% by mass of colorant, the duration of time can range between 1 minute and 60 minutes.

At the second iteration of Flow Process 1 as applied to the second extraction process of method 300, the input feedstock 806 corresponds to intermediate textile feedstock 304, the output product 808 corresponds to purified textile product 311, mixture 809 corresponds to second mixture 310, and extracted material 810 corresponds to elastomeric polymers 314 (e.g., with the solvent removed via evaporation using boiling vessel 802 or another filtration process). At this second iteration, in order to remove the elastomeric polymers of the intermediate textile feedstock 304, the solvent can include a cyclic ketone, such cyclopentanone, cyclohexanone, or a combination thereof. As noted with reference to FIG. 3 and process 300, the solvent used for the first and second extraction processes may be different. Preferably, in order to remove the elastomeric polymers at this second extraction process, the temperature of the condensed solvent solution 805 within the chamber 807 is between about 110° C. and about 150° C., and more preferably between about 130° C. and about 150° C. in association with the contacting. The duration of time can vary (depending on the amount of elastomeric polymers included in intermediate textile feedstock 304 and other factors described herein). In various embodiments, in order to remove all or substantially all elastomeric polymers from the intermediate textile feedstock 304 such that the output product 808 contains less than 1% by mass of elastomeric polymers the duration of time can range between 10 minutes and 60 minutes.

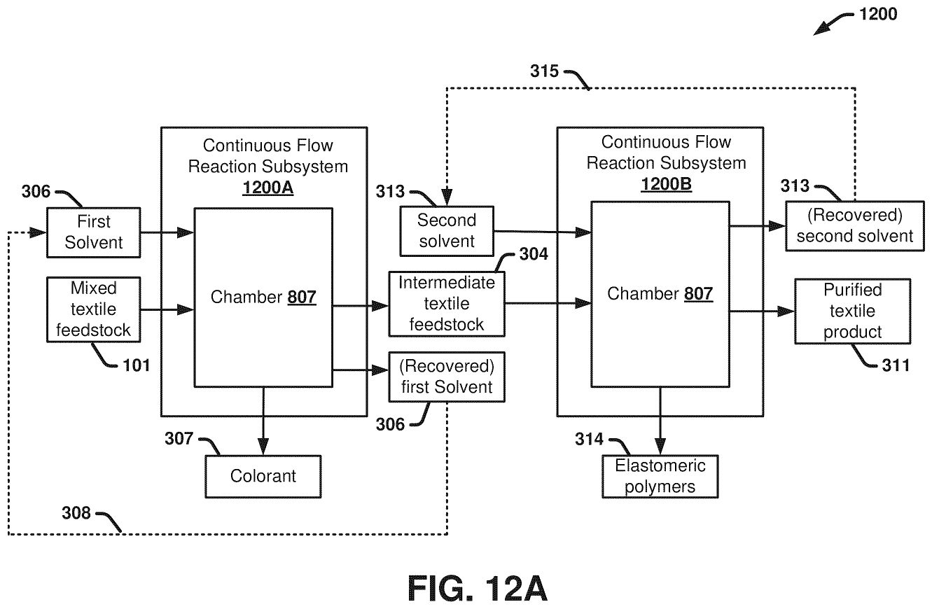

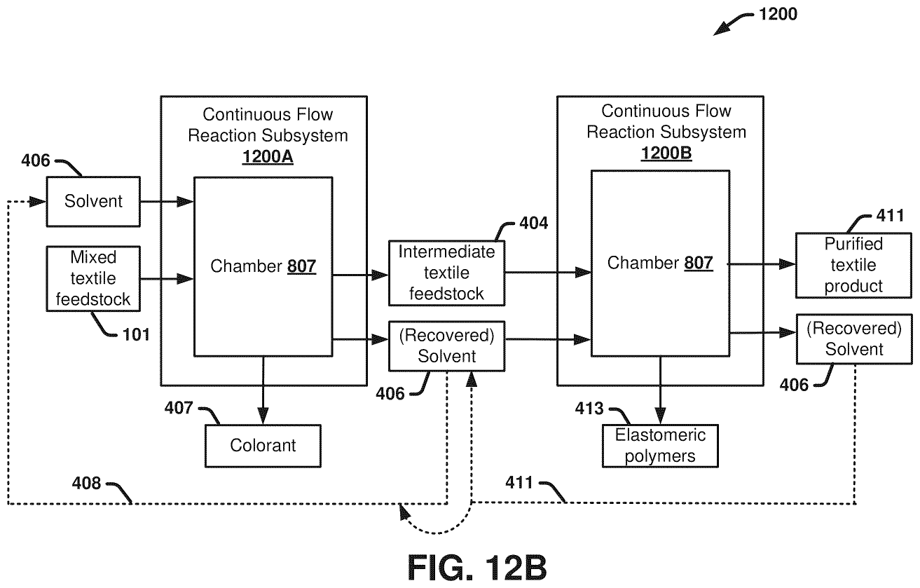

In some implementations of this embodiment, the first and second iterations of Flow Process 1 may be performed using the same system (e.g., system 800). With these implementations, the reaction may be stopped after the first iteration and the solvent is switched while the intermediate textile feedstock 304 is maintained within the chamber 807. In other implementations of this embodiment, the first and second iterations of Flow Process 1 may be performed using separate instances of system 800 (or a similar system). With these implementations, the intermediate textile feedstock 304 may be transferred to the chamber of the second instance of system 800 via mechanical conveyance (as described in greater detail with reference to FIG. 12A).

In various embodiments, using Flow Process 1 as applied to method 400, Flow Process 1 is performed twice, with the first time corresponding to the first extraction process of method 400 performed at 402, and the second time corresponding to the second extraction process of method 400 performed at 409.

In this regard, as applied to method 400, at the first iteration of Flow Process 1, the input feedstock 806 corresponds to mixed textile feedstock 101, the output product 808 corresponds to intermediate textile feedstock 404, mixture 809 corresponds to first mixture 403, and extracted material 810 corresponds to colorant 407 (e.g., with the solvent removed via evaporation using boiling vessel 802 or another filtration process). At this first iteration, in order to selectively remove colorant from the mixed textile feedstock 101, the solvent can include a cyclic ketone (e.g., cyclopentanone, and/or cyclohexanone). Preferably, the temperature of the condensed solvent solution 805 within the chamber 807 is between about 50° C. and about 100° C. in association with the contacting. The duration of time can vary (depending on the amount of colorant included in the mixed textile feedstock 101 and other factors described herein). In various embodiments, in order to remove all or substantially all colorant from the mixed textile feedstock 101 such that the output product 808 contains less than 1% by mass of colorant, the duration of time can range between 1 minute and 60 minutes.

At the second iteration of Flow Process 1 as applied to the second extraction process of method 400, the input feedstock 806 corresponds to intermediate textile feedstock 404, the output product 808 corresponds to purified textile product 411, mixture 809 corresponds to second mixture 410, and extracted material 810 corresponds to elastomeric polymers 413 (e.g., with the solvent removed via evaporation using boiling vessel 802 or another filtration process. At this second iteration, the solvent is the same as with the first iteration, yet the temperature of the condensed solvent solution within the chamber 807 is increased. Preferably, the temperature of the condensed solvent solution 805 within the chamber 807 is between about 110° C. and about 150° C. (and more preferably between about 130° C. and about 150° C.) in association with the contacting in order to remove the elastomeric polymers. The duration of time can vary (depending on the amount of elastomeric polymers included in intermediate textile feedstock 404 and other factors described herein). In various embodiments, in order to remove all or substantially all elastomeric polymers from the intermediate textile feedstock 404 such that the output product 808 contains less than 1% by mass of elastomeric polymers the duration of time can range between 10 minutes and 60 minutes.

In some implementations of this embodiment, the first and second iterations of Flow Process 1 may be performed using the same system (e.g., system 800). With these implementations, the reaction may be adjusted to increase the temperature of the condensed solvent solution after the duration of time needed to remove colorant. The extracted colorant may also be removed from the boiling vessel 802 prior to increasing the temperature and refreshed with new solvent. In other implementations of this embodiment, the first and second iterations of Flow Process 1 may be performed using separate instances of system 800 (or a similar system). With these implementations, the intermediate textile feedstock 404 may be transferred to the chamber of the second instance of system 800 via mechanical conveyance (as described in greater detail with reference to FIG. 12B).

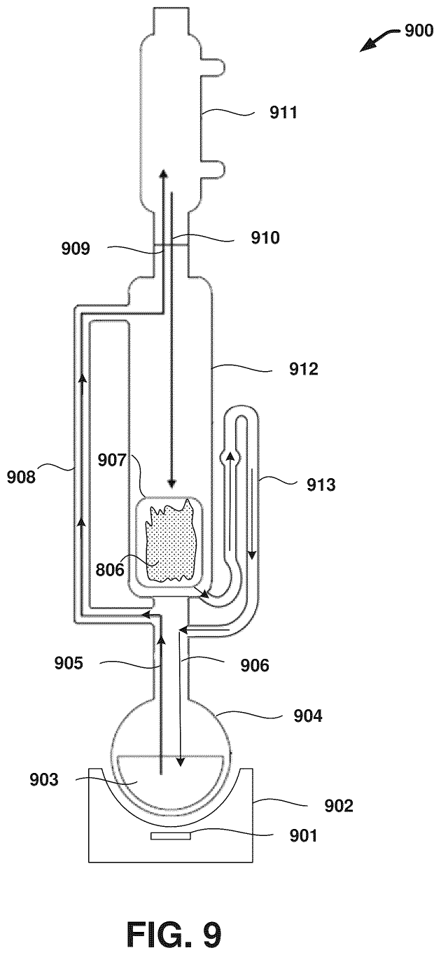

FIG. 9 illustrates another example continuous flow reaction system (hereinafter system 900) in accordance with one or more embodiments described herein. System 900 corresponds to an embodiment of system 800. In accordance with this embodiment, system 900 includes or corresponds to a Soxhlet extraction system.

System 900 includes a boiling vessel 904 (e.g., corresponding to boiling vessel 802), a condenser 911 (e.g., corresponding to condenser 804), a side arm 908 connecting the boiling vessel 904 to the condenser 911, a chamber 912 (e.g., corresponding to chamber 807), a siphon arm 913 connecting the chamber 912 to the boiling vessel 904, and a heating element 902 positioned below the boiling vessel 904 (e.g., corresponding to heating element 901).

Upon initial operation, (fresh) solvent solution 903 (comprising one or more of the disclosed solvents) is placed in the solvent boiling vessel 904, and the input feedstock 806 is placed in the chamber 912. In some embodiments, the chamber 912 can include removable a thimble 907 or basket formed of a porous, heat-resistant material, which holds the input feedstock 806 and allows hot, condensed solvent solution to pass therethrough. The solvent solution 903 in the boiling vessel 904 is heated at least to the solvent boiling point temperature in order to vaporize the solvent via the heating element 902. In other embodiments, the solvent solution 903 in the boiling vessel 904 is heated to a higher temperature than the solvent boiling point. In this manner the temperature of the condensed solvent solution 805 can be controlled to the target temperatures discussed herein when it enters the chamber 912. The heating element 902 can include a thermocouple 901 to monitor and/or control the temperature to which the solvent solution 903 is heated. In some embodiments, another thermocouple may be integrated on or within the chamber 912 to detect the temperature of the condensed solvent solution therein.

Once the solvent has vaporized, the solvent vapor travels from the boiling vessel 904 to the condenser 911 via the side arm 908, as indicated via arrows 905 and 909. In this regard, it should be appreciated that a first opening is provided between the boing vessel 904 and the side arm 908 that connects the boiling vessel 904 to the side arm 908, and a second opening is further provided between the side arm 908 and the condenser 911 that connects the side arm 908 to the condenser 911.

Within the condenser 911, the vapor (e.g., vaporized solvent 803) condenses into a liquid (e.g., condensed solvent solution 805, also referred to as “condensed solvent” or “condensate”) that drips from the condenser 911 into the chamber 912 via gravity (as indicated via arrow 910). In this regard, it should be appreciated that a third opening is provided between the condenser 911 and the chamber 912 that connects the condenser 911 to the chamber 912. The condensed solvent solution thus slowly fills the chamber 912 where it contacts the input feedstock 806 and extracts (some of) the elastomeric polymers and/or colorant and forms a mixture with condensed solvent solution (e.g., mixture 809 comprising solvent and the extracted material 810). The mixture is further directed back into the boiling vessel 904 via the siphon arm 913 automatically at a rate controlled as a function of the siphon level and reflux rate of the siphon arm 913 (as indicated via arrow 906). In some implementations, the amount of the condensed solvent solution relative to the amount of the input feedstock 806 maintained within the chamber 912 over the reaction process is about 1 part by mass to about 10 parts by mass.

In various embodiments, the evaporation-condensation-extraction is repeated in a continuous loop for a duration of time until the input feedstock 806 is free of elastomeric polymers and/or colorant. In addition, the mixed solvent solution remaining in the solvent boiling vessel 904 can be reused until such time that the residue is recovered by evaporation and/or filtration to separate the solvent from the extracted material (e.g., colorant and/or elastomeric polymers) where the former may be reused in additional solvent extractions and the latter may be reused to dye new materials (e.g., as applied to colorant).

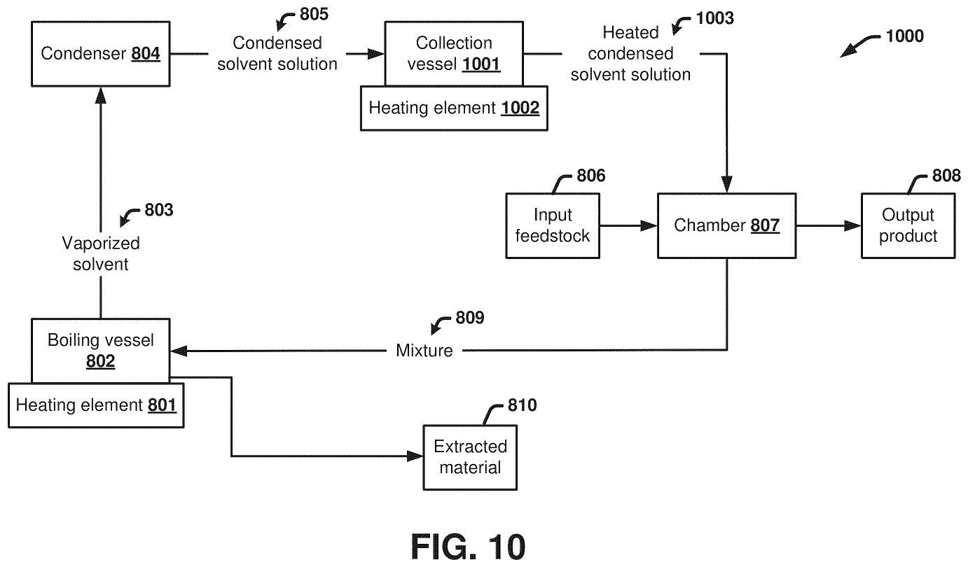

FIG. 10 illustrates another example continuous flow reaction system (hereinafter system 1000) in accordance with one or more embodiments described herein. System 1000 corresponds to system 800 as modified to increase efficiency. Repetitive description of like elements employed in respective embodiments is omitted for sake of brevity. In accordance with this embodiment, system 1000 includes a collection vessel 1001 and another heating element 1002 positioned between the condenser 804 and the chamber 807. The collection vessel 1001 collects the condensed solvent solution 805 which is heated therein by the heating element 1002 to an increased temperature, thereby transforming the condensed solvent solution into heated condensed solvent solution 1003 which is directed into the chamber 807. In other words, in some embodiments, the condensed solvent solution 805 may be heated prior to being directed into the chamber 806. Additionally, or alternatively, the chamber 807 may be heated via another heating element (not shown), to increase the temperature of the condensed solvent solution therein. In either of these embodiments, the temperature of the heated condensed solvent solution 1003 is increased relative to the temperature of the condensed solvent solution 805, which enables precise control of the target temperature for extraction and increases extraction efficiency (e.g., in terms of reducing contact time or exposure duration between the input feedstock 806 and the condensed solvent solution 805). In this regard, although the solvent solution is heated in the boiling vessel 802 via heating element 801, after it evaporates and condenses via the condenser 804, the temperature of the resulting condensed solvent solution 805 solution. For example, assuming the solvent vapor leaves the boiling vessel 802 at or near its boiling point temperature (e.g., about 130° C. as applied to cyclopentanone for example), the temperature of the condensed solvent solution 805 becomes lower than the boiling point temperature.

In this regard, in some embodiments, as opposed to Flow Process 1, a modified flow process (hereinafter Flow Process 2) can be used. Flow Process 2 is the same as Flow Process 1, except for the modification that the condensed solvent solution 805 is heated to the target extraction temperature (and thus transformed into heated condensed solvent solution 1003) prior to introduction into the chamber 906. Additionally, or alternatively, Flow Process 2 modifies Flow Process 1 by heating the chamber 807 and thus the condensed solvent solution 805 therein to the target temperature. As noted throughout, the target temperature can range anywhere from between 50° C. to about 170° C. depending on implementation.

In another embodiment, instead of the chamber 807 being a static chamber, the chamber 807 may include a mechanical conveyance apparatus (hereinafter referred to as a “conveyor”), such as an auger, screw, internal or external helix or spiral, paddle or belt screw, helix, spiral, paddle or belt which moves the input feedstock 806 into and through the chamber 807 and removes the output product 808 out of the chamber following completion of the extraction process. In some embodiments, the heated condensed solvent solution 1003 (or the condensed solvent solution 805) may be gravity fed into the chamber 807. In another embodiment, the heated condensed solvent solution 1003 (or the condensed solvent solution 805) may may be pumped into the chamber 807 (e.g., using any suitable solvent pump). For example, the heated condensed solvent solution 1003 (or the condensed solvent solution 805) be pumped into the chamber 807 in a counter-current flow compared to the flow of the conveyed input feedstock 806. In all embodiments, the temperature and feed rates of the heated condensed solvent solution 1003 (or the condensed solvent solution 805) and the input feedstock 806 should be balanced so that the residence time of the input feedstock 806 within the chamber 807 is sufficient for maximum, optimal extraction of the desired material components (e.g., elastomeric polymers, colorant and/or other additive substances discussed herein).

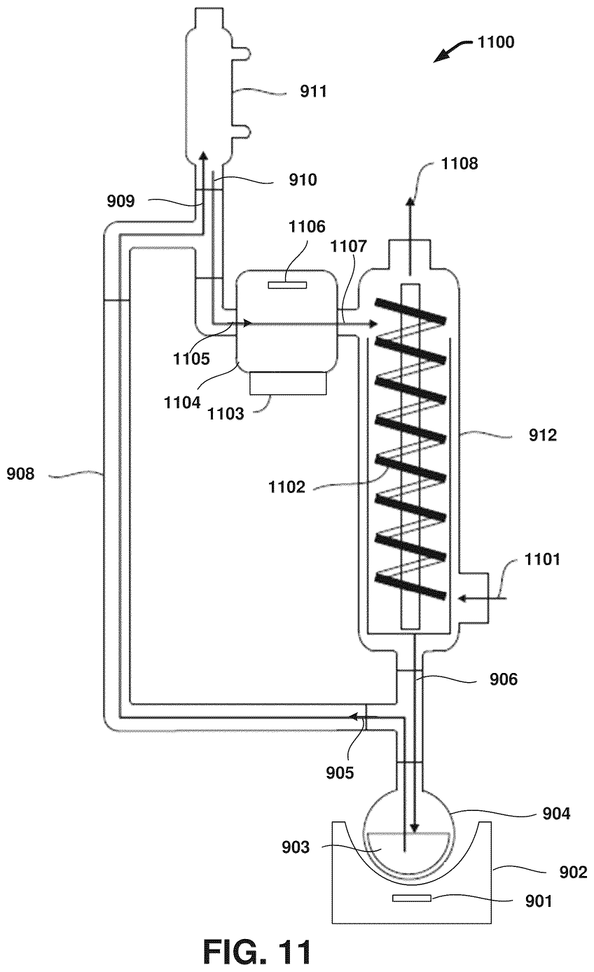

In this regard, FIG. 11 illustrates another example continuous flow reaction system (hereinafter system 1100) in accordance with one or more embodiments described herein. System 1100 corresponds to an embodiment of system 1000. In accordance with this embodiment, system 1100 includes or corresponds to system 900 yet modified to increase extraction efficiency as described above. Repetitive description of like elements employed in respective embodiments is omitted for sake of brevity.

In accordance with this embodiment, chamber 912 includes an inlet opening 1101 via which input feedstock 806 may be fed into the chamber 912 and an outlet opening 1108 via which reacted or output product 808 may be removed from the chamber 1012. In some implementations, the input feedstock 806 may be manually fed into the inlet opening 1101. In other implementations, another mechanical conveyance apparatus may be used to feed the input feedstock 806 into the inlet opening 1101. The chamber 912 also includes a conveyor 1102 (such as an auger, screw, internal or external helix or spiral, paddle, belt or another mechanical conveyance apparatus) that conveys the feedstock material in a countercurrent direction (relative to the flow of the heated condensed solvent solution 1003 in into the chamber as illustrated) through the chamber 912 and carries it out through the outlet opening 1108 once the desired amount of elastomeric polymers and/or colorant have been removed therefrom. With this embodiment, new (unreacted) input feedstock 806 may be continuously fed into the chamber 912 as the output product 808 is removed therefrom, optionally over the duration of the reaction process.

System 1100 also includes a collection vessel 1104 (e.g., corresponding to collection vessel 1001) positioned between the condenser 911 and the chamber 912, and a heating element 1103 (corresponding to heating element 1002) coupled to the collection vessel 1104. In operation, the condensed solvent solution (e.g., condensed solvent solution 805) flows from the condenser 911 into the collection vessel 1104 (as indicated via arrow 1105) where it is heated via heating element 1103, and then out of the collection vessel 1104 and into the chamber 912 (as indicated via arrow 1107). In some implementations, a solvent pump may be integrated on or within the collection vessel 1104 to pump the heated condensed solvent solution out of the collection vessel and into the chamber 912. A thermocouple 1106 may also be integrated on or within the collection vessel 1104 to control and monitor the temperature of the heated, condensed solvent solution.

FIGS. 12A and 12B illustrates another example continuous flow reaction system (hereinafter, system 1200), in accordance with one or more embodiments described herein. System 1200 includes two continuous flow reaction subsystems, respectively referred to a continuous flow reaction subsystem 1200A and continuous flow reaction subsystem 1200B. In some embodiments, each of continuous flow reaction subsystems 1200A and 1200B correspond to system 800. In other embodiments, each of continuous flow reaction subsystems 1200A and 1200B correspond to system 1000. For ease of illustration, aside from the chamber 807, the additional components of continuous flow reaction subsystems 1200A and 1200B have been removed from FIGS. 12A and 12B. In various embodiments, system 1200 can be used for the performance of methods 300 and 400. With these embodiments, the first extraction processes of methods 300 and 400 may be performed using continuous flow reaction subsystem 1200A and the second extraction processes of methods 300 and 400 may be performed using continuous flow reaction subsystem 1200B.

Generally, in accordance with system 1200, the mixed textile feedstock 101 is fed into chamber 807 (preferably via mechanical conveyance) of continuous flow reaction subsystem 1200A where the first extraction processes are performed, resulting in intermediate textile feedstock 304 or intermediate textile feedstock 404. The intermediate textile feedstocks are then removed from chamber 807 of continuous flow reaction subsystem 1200A (preferably via mechanical conveyance) and fed into chamber 807 of continuous flow reaction subsystem 1200B (preferably via mechanical conveyance) where the second extractions are performed, resulting in purified textile product 311 or purified textile product 411, which are then removed from chamber 807 of continuous flow reaction subsystem 1200B (preferably via mechanical conveyance).

With this configuration, system 1200 can be configured to continuously process an incoming stream of mixed textile feedstock 101 over time (e.g., hours, days, weeks, etc.) and generate continuous stream of purified textile products 311 or 411 over time. Thus, system 1200 is suited for industrialized processing of vast amounts of mixed textile feedstock in accordance with the disclosed methods. The purified textile products 311 and/or 411 may further be recycled into a recycled material (e.g., BHET or another type of recycled material).

More particularly, FIG. 12A illustrates usage of continuous flow reaction system 1200 as applied to perform method 300, in accordance with one or more embodiments described herein. Repetitive description of like elements employed in respective embodiments is omitted for sake of brevity. With this embodiment, the input to the chamber 807 of continuous flow reaction subsystem 1200A includes the first solvent 306 (e.g., as condensed solvent solution 805 or heated condensed solvent solution 1003) and mixed textile feedstock 101. The output includes (recovered) colorant 307, (recovered) first solvent 306, and intermediate textile feedstock 304. As previously described and indicated via dashed arrow line 308, the (recovered) first solvent 306 is reused and reintroduced into the chamber 807 of continuous flow reaction subsystem 1200A, repeatedly or continuously over time in association with extracting colorant from the mixed textile feedstock 101 or additional mixed textile feedstock corresponding to the mixed textile feedstock 101 as conveyed into the chamber 807 in association with removing the intermediate textile feedstock 304 therefrom.

The input to the chamber 807 of continuous flow reaction subsystem 1200B includes the second solvent 313 (e.g., as condensed solvent solution 805 or heated condensed solvent solution 1003) and intermediate textile feedstock 304. The output includes (recovered) elastomeric polymers 314, (recovered) second solvent 313, and purified textile product 311. As previously described and indicated via dashed arrow line 315, the (recovered) second solvent 313 is reused and reintroduced into the chamber 807 of continuous flow reaction subsystem 1200B, repeatedly or continuously over time in association with extracting elastomeric polymers from the intermediate textile feedstock 304 (or additional intermediate textile feedstock corresponding to the intermediate textile feedstock 304 as conveyed into the chamber 807 in association with removing the purified textile product 314 therefrom.

FIG. 12B illustrates usage of continuous flow reaction system 1200 as applied to perform method 400, in accordance with one or more embodiments described herein. Repetitive description of like elements employed in respective embodiments is omitted for sake of brevity. With this embodiment, the input to the chamber 807 of continuous flow reaction subsystem 1200B includes solvent 406 (e.g., as condensed solvent solution 805 or heated condensed solvent solution 1003) and mixed textile feedstock 101. The output includes (recovered) colorant 407, (recovered) solvent 406, and intermediate textile feedstock 404. As previously described and indicated via dashed arrow line 408, the (recovered) solvent 406 may be reused and reintroduced into the chamber 807 of continuous flow reaction subsystem 1200A, repeatedly or continuously over time in association with extracting colorant from the mixed textile feedstock 101 or additional mixed textile feedstock corresponding to the mixed textile feedstock 101 as conveyed into the chamber 807 in association with removing the intermediate textile feedstock 404 therefrom.

The input to the chamber 807 of continuous flow reaction subsystem 1200B includes the solvent 406 (e.g., as condensed solvent solution 805 or heated condensed solvent solution 1003) and intermediate textile feedstock 404. As shown in FIG. 12B, the solvent 406 input to the chamber 807 of continuous flow reaction subsystem 1200B corresponds to the (recovered) solvent output from the chamber of continuous flow reaction subsystem 1200A. It should be appreciated that in other embodiments, the an alternative (fresh) source of solvent 406 may be used as input to continuous flow reaction subsystem 1200B. The output includes (recovered) elastomeric polymers 413, (recovered) solvent 406, and purified textile product 411. As previously described and indicated via dashed arrow line 411, the (recovered) solvent 406 may be reused and reintroduced into the chamber 807 of continuous flow reaction subsystem 1200B, repeatedly or continuously over time in association with extracting elastomeric polymers from the intermediate textile feedstock 304 (or additional intermediate textile feedstock corresponding to the intermediate textile feedstock 304 as conveyed into the chamber 807 in association with removing the purified textile product 314 therefrom. Additionally, or alternatively, as also indicated via dashed arrow line 411, the (recovered) solvent 406 may be reused and reintroduced into the chamber 807 of continuous flow reaction subsystem 1200A, repeatedly or continuously over time in association with extracting elastomeric polymers from the mixed textile feedstock 101 (or additional mixed textile feedstock corresponding to the mixed textile feedstock 101.

### Experiments

In example experimental implementations of method 100 using system 900 or a similar system (e.g., a Soxhlet extraction system), various disperse dyes (e.g., those shown in FIG. 2 and others), elastomeric polymers (e.g., spandex and TPE) and other additive components were removed from mixed fabric samples, some colored and some white. These experiments are referred to as Experiments 1-8 and described below. In addition, batch procedures using a high-pressure batch reactor (e.g., Parr high-pressure batch reactor manufactured by the company Parr Instrument Company) were conducted on both white and black spandex mixed fabric to remove spandex. These Experiments are referred to as Experiments 9 and 10 and described below.

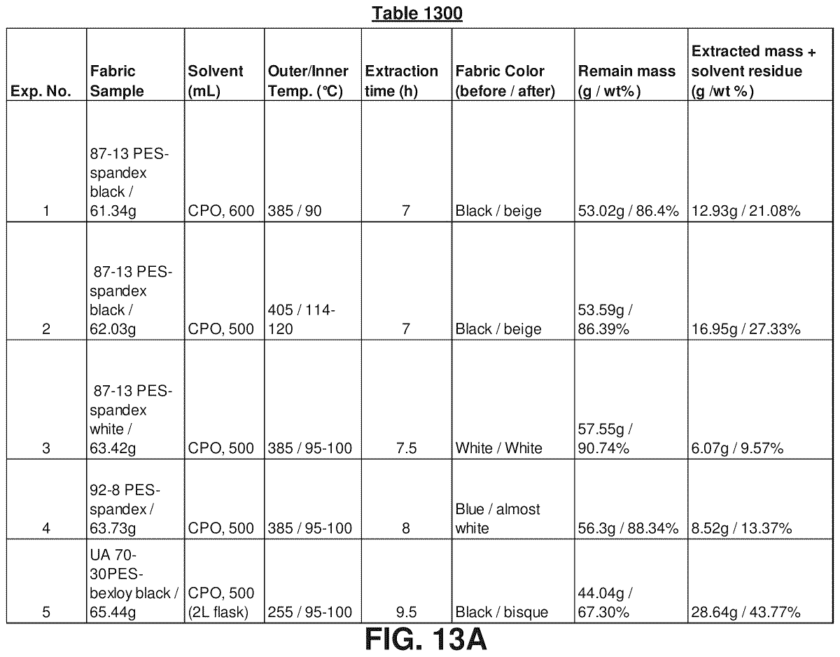

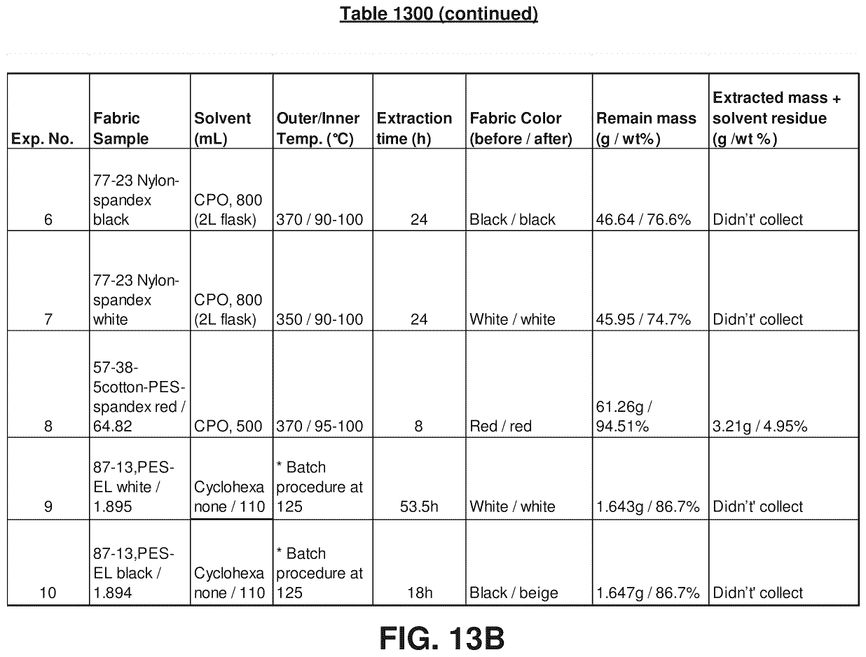

Materials: FIGS. 13A and 13B presents a table (Table 1300) identifying the respective fabric samples used for each of Experiments 1-10. All fabric samples included elastomeric polymers in the form of spandex and/or TPA. Some of the fabric samples were also dyed with a disperse dye (e.g., blacks, blue, and red) and others were white to begin with (e.g., the samples used for Experiments 3, 7 and 9, as indicated in Table 1300. Cyclopentanone was used as the solvent for Experiments 1-8 while cyclohexanone was used as the solvent for Experiments 9 and 10.

Extraction Process of Experiments 1-8: Each of Experiments 1-8 were performed separately for the corresponding fabric samples indicated in Table 1300 using system 900 (or a similar system) with boiling vessels of varying sizes to accommodate the indicated solvent solution amounts (e.g., ranging from 500 milliliters (mL) to 800 mL, as indicated in Tables 1300. The respective fabric samples were placed in a thimble and situated therein to assure the sample remained below the refluxed liquid level during extraction. The thimble was then loaded into the chamber and the condenser was attached with a thermocouple in the chamber to detect the temperature of the condensed solvent solution therein (referred to as the inner temperature). The chamber 912 was covered with glass wool for thermal insulation. The indicated amount of fresh solvent solution was added to the boiling vessel, which was also equipped with a magnetic stir bar. The heating mantle was then placed under the boiling vessel with a thermocouple embedded between for temperature control (referred to herein as the outer temperature). The heating mantel was then set to the outer temperatures indicated in Table 1300 for the respective Experiments 1-8 and maintained for the duration of the extraction times indicated in Table 1300 (which ranged between 7 hours and 24 hours). The inner temperatures of Experiments 1-8 are also indicated in Table 1300, which ranged between 90° C. and about 120° C. After this time the heating was removed and the fabric was removed from the apparatus and dried in a vacuum oven at 70-75° C.

Extraction Process of Experiments 9 and 10: Each of Experiments 9 and 10 were performed separately for the corresponding fabric samples indicated in Table 1300 using a high-pressure batch reactor (e.g., corresponding to system 500). These reactions were respectively carried out of convenience for 53.5 hours and 18 hours at a temperature of 125° C.

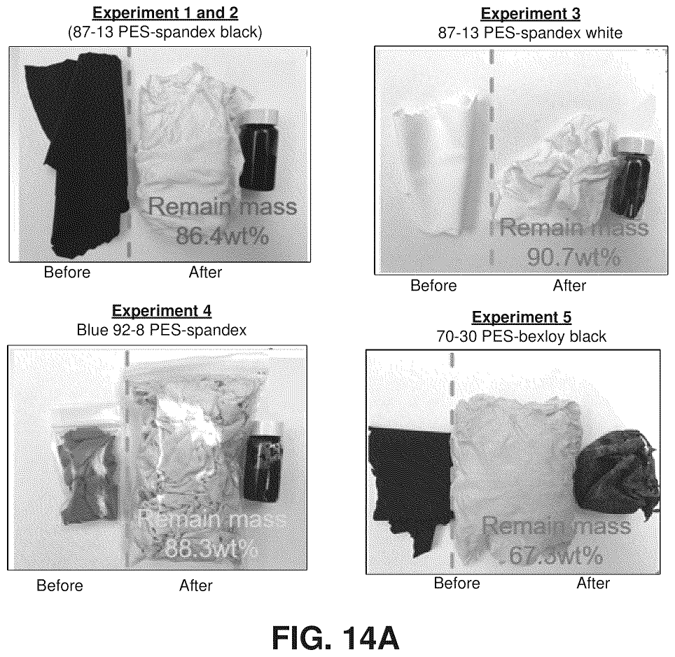

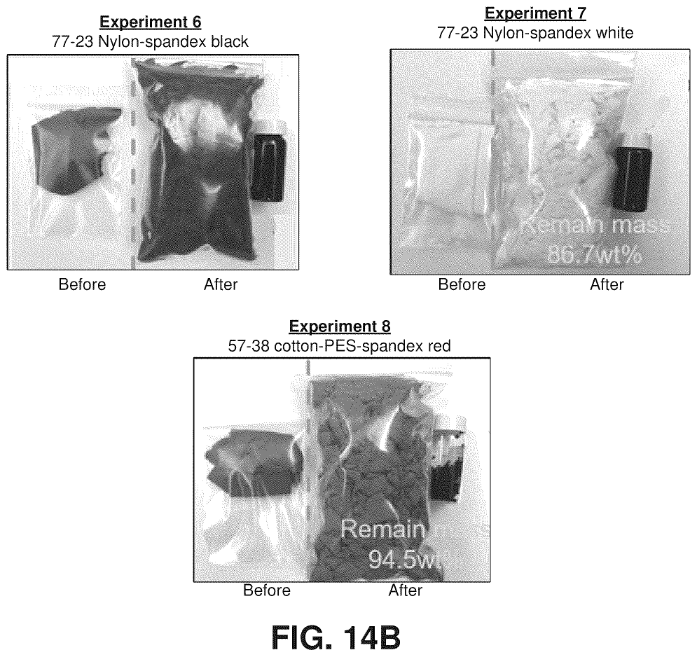

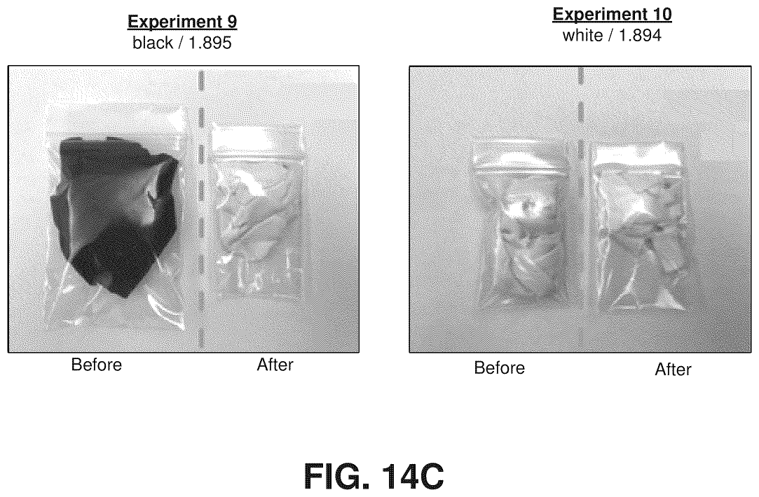

Results: The results of experiments 1-10 are indicated in Table 1300. In addition, FIGS. 14A-14C present images of the respective fabric samples used in Experiments 1-10 before and after extraction.

As indicated in Table 1300, for Experiments 1-8, which were performed using cyclopentanone solvent under continuous reflux conditions, substantial removal of elastomeric polymers and disperse colorants was observed across all tested fabric types. In Experiment 1 (87-13 PES—spandex black), the fabric transitioned from black to beige following 7 hours of extraction at an outer temperature of 385° C. and inner temperature of 90° C., with the remaining fabric mass reduced to 53.02 g (86.4 wt %) and the extracted mass (including solvent residue) measured at 12.93 g (21.08 wt %). Experiment 2, performed on a similar PES—spandex black sample but at a higher outer temperature of 405° C. and an inner temperature of 114-120° C., produced a comparable bleaching outcome (black to beige) and a similar remaining mass of 53.59 g (86.39 wt %), with 16.95 g (27.33 wt %) removed.

Experiment 3 (PES—spandex white) demonstrated that the solvent system does not appreciably affect undyed polyester fibers, as the sample remained white before and after extraction, with 57.55 g (90.74 wt %) of mass remaining and 6.07 g (9.57 wt %) removed. Similarly, Experiment 4 (92-8 PES—spandex blue) produced a marked color change from blue to almost white, with 56.3 g (88.34 wt %) remaining and 8.52 g (13.37 wt %) extracted.

Experiment 5 (70-30 PES—bexley black) resulted in a substantial discoloration from black to bisque following 9.5 hours of extraction and exhibited a more pronounced mass loss relative to other samples, with 44.04 g (67.30 wt %) remaining and 28.64 g (43.77 wt %) removed. Experiments 6 and 7 (77-23 nylon—spandex blends) showed removal of elastomeric polymers while preserving the nylon fiber color: Experiment 6 (black) remained black, and Experiment 7 (white) remained white after extraction. These samples retained 46.64 g (76.6 wt %) and 45.95 g (74.7 wt %), respectively. The extracted mass from these nylon-based samples was not collected due to experimental constraints.

Experiment 8 (57-38-5 cotton-polyester—spandex red) also demonstrated selective extraction behavior. The fabric remained red following 8 hours of cyclopentanone extraction; however, a measurable mass loss of 3.21 g (4.95 wt %) occurred, reflecting removal of elastomeric and additive components incorporated within the polyester fraction.

Experiments 9 and 10 were performed in a high-pressure batch reactor using cyclohexanone solvent at 125° C. to remove elastomeric polymers from white and black PES-EL blends. Experiment 9 (white) remained white before and after extraction, with 1.643 g (86.7 wt %) of mass retained. Experiment 10 (black) changed from black to beige under the same conditions and retained 1.647 g (86.7 wt %). In both cases the extracted mass was not collected, but the observed mass loss and color changes confirm removal of spandex and associated additives.

Across all experiments, the data demonstrates that the first extraction process of method 100 effectively removes elastomeric polymers and disperse colorants from a wide range of polyester-blend fabric compositions while preserving the integrity and color of non-dyed or dye-insensitive fibers such as nylon and cotton. The observed mass reductions, in combination with significant color changes in dyed samples, confirm that the cyclic ketone solvent system consistently penetrates and extracts elastomeric components and disperse colorants under the tested conditions.

As illustrated in FIGS. 14A-14C, for most of the Experiments involving fabric samples dyed with disperse dye (e.g., Experiments 1, 2, 4, 5 and 9), the colorant was entirely or substantially removed. As indicated in Table 1300, for each of Experiments 1-10, a significant amount of mass (reflected in the remaining mass of the treated fabric) of extracted material was removed from all samples. The extracted material included both colorant and elastomeric polymers.

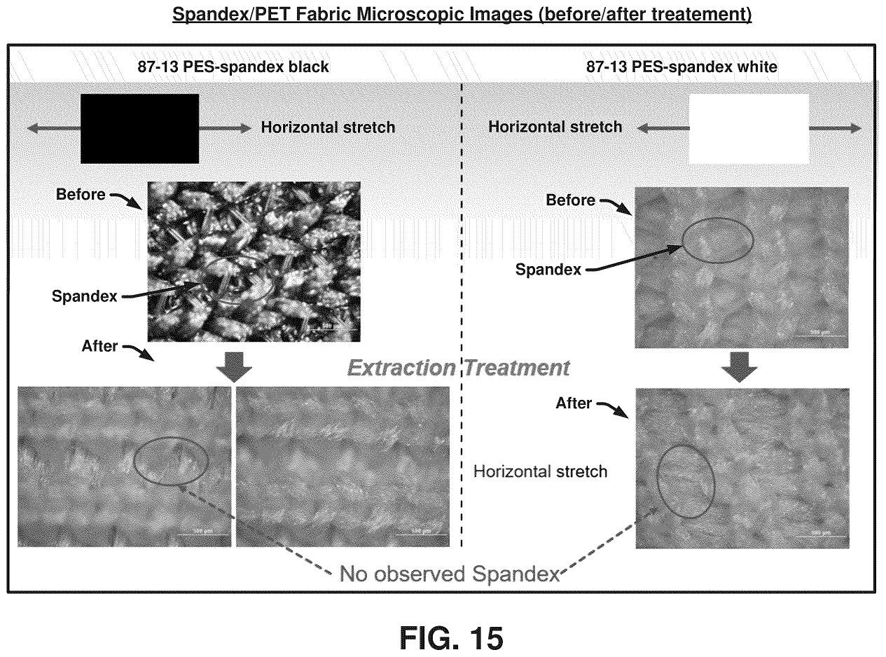

FIG. 15 presents microscopic images of the fabric samples used in Experiments 9 and 10 while being stretched horizontally. As shown in FIG. 15, no spandex was observed in the respective fabric samples following the batch extraction processes using cyclohexanone.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

The Experimental examples described herein (e.g., Experiments A and 1-10) are set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric, or can be elevated relative to the boiling point and vapor pressure of a given solvent and the desired extraction temperature. All components were obtained commercially unless otherwise indicated.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
contacting a heated solution comprising a solvent to a mixed textile feedstock as positioned within a vessel or chamber, wherein the mixed textile feedstock comprises elastomeric polymers and one or more other textile materials, and wherein the solvent comprises a cyclic ketone; and
removing at least some of the elastomeric polymers as a result of the contacting, resulting in a transformation of the mixed textile feedstock into a purified textile product that excludes the at least some of the elastomeric polymers.

2. The method of claim 1, wherein the cyclic ketone comprises 5 to 10 carbon atoms.

3. The method of claim 1, wherein the cyclic ketone comprises is selected from the group consisting of cyclopentanone, cyclohexanone.

4. The method of claim 1, wherein the heated solution is heated to a temperature between about 50 degrees Celsius to about 170 degrees Celsius.

5. The method of claim 1, wherein the one or more other textile materials comprise a polyester material selected from the group consisting of: polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly(butylene succinate) (PBS), poly(butylene adipate) (PBA) and other poly dialkyl diesters, polyalkalene alkanoates polyalkylene succinates, adipates, polyhydroxyalkanoates, poly(lactic acid), and combinations thereof.

6. The method of claim 5, wherein the polyester material comprises PET and wherein the method further comprises:
transforming the PET into Bis(2-hydroxyethyl)terephthalate (BHET) using glycolysis, and repolymerizing the BHET to form a recycled polyester material.

7. The method of claim 1, wherein one or more other textile materials are selected from the group consisting of: a cotton material, a nylon material, an acrylate material, a polyolefin material, an animal fiber material, or man-made cellulosic fiber material.

8. The method of claim 1, wherein the one or more other textile materials comprises at least two materials selected from the group consisting of: a polyester material, a cotton material, a polyamide material, a nylon material, an acrylate material, a polyolefin material, an animal fiber material, or man-made cellulosic fiber material.

9. The method of claim 1, wherein the mixed textile feedstock further comprises a colorant, wherein the heated solution is heated to a temperature between about 120 degrees Celsius an about 150 degrees Celsius, wherein the removing further comprises removing at least some of the colorant as a result of the contacting, resulting in the purified textile product further excluding the at least some of the colorant, and a mixture comprising the at least some of the elastomeric polymers and the at least some of the colorant.

10. The method of claim 9, further comprises:
extracting the at least some of the colorant from the mixture, resulting in isolated colorant; and
extracting the at least some of the elastomeric polymers from the mixture, resulting in isolated elastomeric polymers.

11. The method of claim 1, wherein the mixed textile feedstock further comprises one or more additive components selected from the group consisting of: a lubricant agent, a brightener agent, a perfluoroalkyl substance, a polyfluoroalkyl substance, a scouring agent, an anti-foam agent, a leveling agent, an antistatic compound, a water repellent, an emulsifier, a surfactant, a flame retardant, a wicking agent, dirt and grime, wherein the removing further comprises removing at least some of the one or more additive components as a result of the contacting, and wherein the purified textile product excludes the at least some of the one or more additive components.

12. A method for separating components of a mixed textile feedstock, wherein the mixed textile feedstock comprises a colorant, elastomeric polymers and one or more other textile materials, the method comprising:
extracting at least some of the colorant from the mixed textile feedstock using a first extraction process resulting in an intermediate textile feedstock, wherein the first extraction process comprises contacting the mixed textile feedstock to a first heated solution comprising a first solvent; and
extracting at least some of the elastomeric polymers from the intermediate textile feedstock using a second extraction process, resulting in a purified textile product that excludes the at least some of the colorant and the at least some of the elastomeric polymers, wherein the second extraction process comprises contacting the intermediate textile feedstock to a second heated solution comprising a second solvent different from the first solvent, wherein the first solvent and the second solvent are selected from the first group consisting of an alcohol, an ether, an ester, and a ketone.

13. The method of claim 12, wherein the first group comprises cyclobutanone, cyclopentanone, cyclohexanone, 1,4-dioxane, 1,3-dioxolane, tetrahydrofuran, 2-methyl tetrahydrofuran, dimethyl carbonate, diethyl carbonate, ethyl lactate and ethyl acetate, and wherein the second solvent is selected from the second group consisting of cyclopentanone and cyclohexanone.

14. The method of claim 12, wherein the first heated solution is heated to a first temperature between about 50 degrees Celsius to about 110 degrees Celsius, and wherein the second heated solution is heated to a second temperature between about 110 degrees Celsius to about 150 degrees Celsius.

15. The method of claim 12, wherein the first extraction process results in a mixture comprising the first solvent and the at least some of the colorant, and wherein the method further comprises:
separating the at least some of the colorant and the first solvent from the mixture, resulting in recovered colorant and recovered first solvent; and
reusing the recovered first solvent in another performance of the first extraction process as applied to additional mixed textile feedstock corresponding to the mixed textile feedstock.

16. The method of claim 12, wherein the second extraction process results in a mixture comprising the second solvent and the at least some of the elastomeric polymers, and wherein the method further comprises:
separating the at least some of the elastomeric polymers and the second solvent from the mixture, resulting in recovered elastomeric polymers and recovered second solvent; and
reusing the recovered second solvent in another performance of the second extraction process as applied to additional intermediate textile feedstock corresponding to the intermediate textile feedstock.

17. The method of claim 12, wherein the one or more other textile materials comprises a polyester material selected from the group consisting of: polyethylene terephthalate (PET), polyethylene naphthalate (PEN), polybutylene terephthalate (PBT), polytrimethylene terephthalate (PTT), polyethylene furanoate (PEF), PET-G (polycyclohexanedimethanol diesters), polyisophthalate, poly(butylene succinate) (PBS), poly(butylene adipate) (PBA) and other poly dialkyl diesters, polyalkalene alkanoates polyalkylene succinates, adipates, polyhydroxyalkanoates, poly(lactic acid), and combinations thereof.

18. The method of claim 17, wherein the polyester material comprises PET and wherein the method further comprises:
transforming the purified fabric feedstock into a recycled polyester material via a chemical recycling process or mechanical recycling process.

19. The method of claim 12, wherein the one or more other textile materials are selected from the group consisting of: a polyester material, a cotton material, a nylon material, an acrylate material, a polyolefin material, an animal fiber material, or man-made cellulosic fiber material.

20. A method for separating components of a mixed textile feedstock, wherein the mixed textile feedstock comprises a colorant, elastomeric polymers, and one or more other textile materials, the method comprising:
extracting at least some of the colorant from the textile feedstock using a first extraction process resulting in an intermediate textile feedstock, wherein the first extraction process comprises contacting the mixed textile feedstock to a solution comprising a solvent in association with heating the solution to a first temperature, wherein the solvent comprises a cyclic ketone; and
extracting at least some of the elastomeric polymers from the intermediate textile feedstock using a second extraction process, resulting in a purified textile product that excludes the at least some of the colorant and the at least some of the elastomeric polymers, wherein the second extraction process comprises contacting the intermediate textile feedstock to the solution in association with heating the solution to a second temperature higher than the first temperature.

21. The method of claim 20, wherein the cyclic ketone is selected from the group consisting of cyclobutanone, cyclopentanone and cyclohexanone.

22. The method of claim 20, wherein the first temperature is between about 50 degrees Celsius to about 110 degrees Celsius, and wherein the second temperature between about 150 degrees Celsius to about 170 degrees Celsius.

23. The method of claim 20, wherein the first extraction process results in a mixture comprising the solvent and the at least some of the colorant, and wherein the method further comprises:
separating the at least some of the colorant from the solvent in the mixture, resulting in an recovered colorant and recovered solvent; and
reusing the recovered solvent in the solution in association with at least one of: the first extraction process, the second extraction process, or another performance of the first extraction process as applied to additional textile feedstock corresponding to the textile feedstock.

24. The method of claim 20, wherein the second extraction process results in a mixture comprising the solvent and the at least some of the elastomeric polymers, and wherein the method further comprises:
separating the at least some of the elastomeric polymers from the solvent in the mixture, resulting in recovered elastomeric polymers and recovered solvent; and
reusing the recovered solvent in the solution in association with at least one of: the second extraction process, another performance of the first extraction as applied to additional textile feedstock corresponding to the textile feedstock, or another performance of the second extraction process as applied to additional intermediate textile feedstock corresponding to the intermediate textile feedstock.

25. The method of claim 20, wherein the one or more other textile materials are selected from the consisting of: a polyester material, a cotton material, polyamide material, a nylon material, an acrylate material, a polyolefin material, an animal fiber material, or man-made cellulosic fiber material.

26. The method of claim 20, wherein the first extraction process and the second extraction process respectively comprise a continuous flow reaction process using a continuous flow reaction system.
